(19) United States
(12) Patent Application Publication
(10) Pub. No.: US 2005/0111832 A1
(43) Pub. Date: May 26, 2005

(54) Data processing apparatus for controlling video recording and video quality

(76) Inventors: Osamu Okauchi, Osaka (JP); Kazuhiko Nakamura, Osaka (JP); Shunji Ohara, Osaka (JP)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 10/960,603

(22) Filed: Oct. 7, 2004

(30) Foreign Application Priority Data
Oct. 8, 2003 (JP) 2003-349248
Mar. 15, 2004 (JP) 2004-072552

(51) Int. Cl. H04N 5/781

(52) U.S. Cl. 386/95; 386/125

(57) ABSTRACT

A data processing apparatus can write a video stream related to video on a recording medium. The data processing apparatus includes: a signal acquisition section for acquiring a video signal related to the video; a type identification section for identifying a type of the video based on the video signal, the type of the video being determined in accordance with picture counts of the video displayed per unit time; a stream generator for generating a video stream based on the video signal; a controller for determining, based on the type of the video, whether to disable the writing of the video stream or to enable the writing of the video stream with lowered video quality; and a writing section for controlling, based on the decision of the controller, the writing of the video stream to the recording medium.

### BACKGROUND OF THE INVENTION

1. Field of the Invention

The present invention relates to a technique for generating a data stream after reception of an image, audio or other signal and writing the data stream to a recording medium such as an optical disc.

2. Description of the Related Art

A technique has been hitherto known for recording pictures to a film such as a silver salt film and playing back the pictures as a movie (more specifically, a cinema movie). A cinema movie, for example, is a “film material video” (film video) shot and screened using a film. Ordinary cinema movies are shown at the rate of 24 frames a second.

On the other hand, NTSC (National Television Standards Committee) system video (NTSC video)—NTSC employed in Japanese and US television broadcasting—is shot at 30 frames a second (to be precise, 29.97 frames a second). Since one frame of image consists of two fields of images (an odd and an even field), NTSC video is shot and played back at approximately 60 fields a second (to be precise, 59.94 fields a second).

To record film video created at 24 frames a second using NTSC-compliant equipment, the 24-frame-per-second video must be converted to 30-frame 60-field-per-second NTSC video (so-called telecine conversion) to ensure consistency between respective video types.

FIG. 31 shows an example of the telecine conversion using the 2-3 pull-down system. With the 2-3 pull-down system, two frames of film video produce five fields of images in NTSC video. More specifically, the first frame (A) of film video produces three fields of images in NTSC video, with the second frame (B) producing two fields of images. Similarly, the third frame (C) produces three fields of images, with the fourth frame (D) producing two fields of images. Sixty fields of images are obtained by repeating this process up to the 24th frame. The 2-3 pull-down system is widely used to play back film video on NTSC-compliant equipment such as a television.

Here, we consider the process by which NTSC video, converted from 24-frame-per-second film video with the 2-3 pull-down system, is recorded to a medium (e.g., DVD-RAM disc). Japanese Patent Application Laid-Open Publication No. 1993-183864, for example, discloses a recording/playback device having a pull-down detection circuit for efficient encoding of the video signal.

FIG. 32 shows a configuration of the functional block of a conventional recording/playback device 320. The recording/playback device 320 receives an NTSC video signal (2-3 pull-down signal) converted with the 2-3 pull-down system and detects the fields overlapped during conversion with a pull-down detection section 1103. A controller 1201 instructs a moving picture stream generator 1102 to remove the detected fields as redundant fields. The moving picture stream generator 1102 omits the specified fields, encoding only the required fields. This allows creating a moving picture stream for the film video. A writing section 1200 writes the moving picture stream to a DVD-RAM disc 131 via a pickup 130. It is to be noted that the 2-3 pull-down signal that has been input may separately contain an audio signal.

It is to be noted that the playback process is conducted as described below in the recording/reproduction device 320. A playback section 1202 reads out the moving picture stream from the DVD-RAM disc 131 via the pickup 130 based on an instruction from a playback controller 1203. A moving stream decoder 1111 decodes the moving picture stream of the film video that has been read out and at the same time proceeds with a 2-3 pull-down conversion to output the stream as NTSC video, outputting an NTSC video signal from a video signal output section 1110. When audio data is contained in the moving picture stream, the moving stream decoding section 1111 also decodes the audio data, outputting the data as an audio signal from an audio signal output section 1112.

Recent years have seen establishment of the DV and DVD standards, with progress made in the camera performance improvement. For example, consumer-oriented high-performance video cameras capable of shooting HDTV video are commercially available at affordable prices, allowing easy shooting of high-quality moving pictures. On the other hand, an environment is in the making where various moving picture content including cinema movies can be distributed without degradation as a result of proliferation of recording/playback devices using digital recording media such as a DVD recorder and widespread use of personal computers (hereinafter “PCs”), the Internet and others.

As a result of proliferation of equipment, content created/copied unlawfully without the copyright owner's consent (so-called “pirated” content) is in circulation, threatening the rights of copyright owners. For example, content made by shooting a cinema movie being shown in a theater with a video camera is in circulation. Since the cinema movie being shot generally involves a copyright, countermeasures are needed to protect the copyright. In particular, shooting a cinema movie being shown using a high-performance video camera capable of shooting HDTV video results in a sufficiently watchable cinema movie with high image quality being copied, requiring immediate countermeasures.

### SUMMARY OF THE INVENTION

It is an object of the present invention to judge whether the shot target is video subject to copyright protection and limit the recording of the video if the video is subject to copyright protection.

A data processing apparatus according to a preferred embodiment of the present invention is used to record a video stream related to video to a recording medium. The data processing apparatus preferably includes a signal acquisition section, a type identification section, a stream generator, a controller and a writing section. The signal acquisition section preferably acquires a video signal related to the video. The type identification section preferably identifies a type of the video based on the video signal. The type of the video is determined in accordance with picture counts of the video displayed per unit time. The stream generator preferably generates a video stream based on the video signal. The controller preferably determines, based on the type of the video, whether to disable the writing of the video stream or to enable the writing of the video stream with lowered video quality. The writing section preferably controls, based on the decision of the controller, the writing of the video stream to the recording medium.

In one preferred embodiment of the present invention, the controller preferably disables the writing of the video stream in the case where the type of the video is a movie.

In this particular preferred embodiment, the data processing apparatus further includes an adjustment section. The adjustment section preferably selects a video quality based on the type of the video. The stream generator preferably generates the video stream with selected video quality.

More specifically, in the case where the type of the video matches a predetermined type, the controller preferably determines to enable the writing of the video stream with lowered video quality. The adjustment section preferably selects video quality lower than that set in advance.

In another preferred embodiment, in the case where the type of the video does not match a predetermined type, the controller preferably determines to enable the writing of the video stream with the video quality preserved. The adjustment section preferably selects the same video quality as set in advance.

In still another preferred embodiment, the adjustment section preferably selects the video quality in relation to a resolution.

In yet another preferred embodiment, the type identification section preferably includes a detection section and a judgement section. The detection section preferably continuously receives the video signal and preferably detects whether first and second images consisting of each picture of the video, match or mismatch. The judgement section preferably judges the type of the video based on the detection result.

In still another preferred embodiment, the detection section preferably includes a first memory, a second memory, and a comparator. The first memory preferably stores data of the first image. The second memory preferably stores data of the second image. The comparator preferably compares the data in the first memory with that in the second memory and preferably detects whether the first and second images match each other.

More specifically, the judgement section continuously preferably receives each detection result and preferably specifies the type of the video based on a pattern of match and mismatch appeared in the each detection result.

In another preferred embodiment, the data processing apparatus further includes a management information generator. The management information generator preferably generates judgement information indicating at which of a first resolution and a second resolution lower than the first resolution the video was encoded. The management information generator preferably manages the judgement information in association with the video stream. The writing section further writes the judgement information to the recording medium.

In still another preferred embodiment, the management information generator preferably manages a plurality of contents, each of which includes a pair of the judgement information and the video stream associated with each other. The data processing apparatus further includes a management file generator. The management file generator preferably extracts the judgement information from each content and preferably generates a content management file having entries for each content.

A data processing apparatus according to a preferred embodiment of the present invention is used to read out a video stream related to video from a recording medium to output a video signal. The video stream and management information are preferably written on the recording medium. The management information preferably contains judgement information indicating the video being encoded in first video quality and second video quality lower than the first video quality. The data processing apparatus preferably includes a readout section, an extraction section, a decoder, and an output section. The readout section preferably reads out the video stream and the management information from the recording medium. The extraction section preferably extracts the judgement information from the management information and preferably generates, based on the judgement information, quality display data indicating at which of the first video quality and the second video quality the video was encoded. The decoder preferably decodes the video stream to generate a video signal. The output section preferably outputs the quality display data and the video signal in correspondence with each other.

In yet another preferred embodiment, in the case where the type of the video matches a predetermined type, the judgement information preferably indicates that the video was encoded at the second video quality. In the case where the type of the video does not match a predetermined type, the judgement information preferably indicates that the video was encoded at the first video quality.

In one preferred embodiment of the present invention, the data processing apparatus further includes a superimposing processor. The superimposing processor preferably superimposes the quality display data on the video signal. The output section preferably outputs the video signal superimposed with the quality display data.

In this particular preferred embodiment, the output section preferably includes a video signal output section which preferably outputs the video signal, and a display output section which preferably displays the quality display data.

More specifically, a plurality of contents are stored on the recording medium, each of which includes a pair of the judgement information and the video stream associated with each other, each piece of the judgement information is preferably stored in a content management file having an entry for each piece of the content. The extraction section preferably extracts the judgement information from the content management file to generate list data for displaying content corresponding to each entry and the quality display data in correspondence with each other.

A data processing method according to a preferred embodiment of the present invention is used to write a video stream related to video on a recording medium. The data processing method preferably includes steps of: acquiring a video signal related to the video; identifying a type of the video based on the video signal, the type of the video being determined in accordance with picture counts of the video displayed per unit time; generating a video stream based on the video signal; determining, based on the type of the video, whether to disable the writing of the video stream or to enable the writing of the video stream with lowered video quality; and controlling, based on the determination, the writing of the video stream to the recording medium.

In another preferred embodiment, the step of determining preferably determines to disable the writing of the video stream in the case where the type of the video is a movie.

In still another preferred embodiment, the data processing method further includes a step of selecting a video quality based on the type of the video. The steps of generating preferably generates the video stream with selected video quality.

In yet another preferred embodiment, in the case where the type of the video matches a predetermined type, the step of determining preferably determines to enable the writing of the video stream with lowered video quality. The step of selecting preferably selects video quality lower than that set in advance.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

The above and other objects, aspects, features and advantages of the present invention will become more apparent from the following detailed description when taken in conjunction with the accompanying drawings.

FIG. 1 is a view showing a configuration of the functional block of a video camera 1 according to an embodiment of the present invention.

FIG. 2 is a view showing a configuration of the functional block of a moving picture stream generator 102.

FIG. 3 is a view showing a configuration of the functional block of a video type identification section 119.

FIG. 4 is a view showing the operation timings of the individual functional blocks of detection section 103.

FIG. 5 is a view showing the process performed in the video camera 1 when a person, scenery, etc. is shot by the video camera 1.

FIG. 6 is a view showing the process performed in the video camera 1 when a cinema movie projected onto the screen is shot mainly by the video camera 1.

FIG. 7 is a flowchart showing the steps of the recording process of the video camera 1 according to an embodiment 1.

FIG. 8 is a view showing a configuration of the functional block of a video camera 2 according to an embodiment 2.

FIG. 9 is a view showing a configuration of the functional block of a moving picture stream generation section 202.

FIG. 10 is a flowchart showing the steps of the recording process of the video camera 2 according to the embodiment 2.

FIG. 11 is a view showing a configuration of the functional block of a video camera 3 according to an embodiment 3.

FIG. 12 is a view showing the relationship between a chronological data file 12 and a management file 14 according to the embodiment 3.

FIG. 13 is a view showing the data structures of the chronological data file 12 and the management file 14 stored on an optical disc 131.

FIG. 14 is a view showing the more detailed data structure of a moving picture stream 11.

FIG. 15 is a view showing the atom structure of management information 13.

FIG. 16 is a view showing the stream data section in a moving picture file, the chunk structure and an atom (sample table atom) 18 within the management file corresponding to the moving picture file.

FIG. 17 is a view showing in more detail the atom structure of a sample description atom 311 of a sample table atom 18.

FIG. 18 is a view showing the data structure of encoding information 518.

FIG. 19 is a view showing the range to which each piece of judgement information is applied.

FIG. 20 is a view showing the steps of the recording process of the video camera 3 according to the embodiment 3.

FIG. 21 is a view showing the steps of the playback process of the video camera 3 according to the embodiment 3.

FIG. 22 is a view showing a first example of the playback and display on the TV monitor.

FIG. 23 is a view showing a second example of the playback and display on the TV monitor.

FIG. 24 is a view showing a third example of the playback and display on the TV monitor.

FIG. 25 is a view showing a configuration of the functional block of a video camera 4 according to an embodiment 4.

FIG. 26 is a view showing the steps of the recording process of the video camera 4 according to the embodiment 4.

FIG. 27 is a view showing the data structure of a content management file 270.

FIG. 28 is a view showing an example of a content list display screen displayed based on the content management file.

FIG. 29 is a view showing the relationship between a total pixel area 291 and an effective pixel area 292 in relation to an imaging device 290.

FIG. 30 is a schematic diagram of the shooting of a cinema movie projected onto the screen using the imaging device 290.

FIG. 31 is a view showing an example of the telecine conversion using the 2-3 pull-down system.

FIG. 32 is a view showing a configuration of the functional block of a conventional recording 0/playback device 320.

### DETAILED DESCRIPTION OF PREFERRED EMBODIMENTS

Embodiments of the data processing apparatus according to the present invention will now be described with reference to the accompanying drawings. In the embodiments below, description will be made assuming that the data processing apparatus is a video camera.

In the present specification, description will be given using the terms defined as described below.

Video: Image displayed by switching a plurality of pictures one after another at a given vertical scan frequency. For example, the vertical scan frequency for switching 30 pictures per unit time (one second) is 30 Hz. The Video may include moving pictures and still images, texts such as subtitles and graphics.

Picture: Frame image composed of two field images, one of which is made from odd lines and the other of which from one even lines, in the interlaced system. Picture is one frame image in the progressive system. Picture encompasses both the frame and the field. It is to be noted that one picture of video (in particular, one picture of the video recorded on a reel of film) is also occasionally referred to as “one frame.” The interlaced system is not employed in ordinary cinema movies. Each of the cinema movies is shown by switching 24 pictures (i.e. 24 frames) per second.

SD (Standard Definition) video: Video in standard resolution quality (480i video in the NTSC system, 576i video in the PAL system).

HD (High Definition) video: Video in high resolution quality other than the above SD video (e.g., HDTV video).

More specific examples, related to moving pictures of SD and HD video, are shown in Tables 1 and 2. Note that 24p or 23.976p HD video in Table 2 is called film material video.

TABLE 1
Resolution (Line Count) + Scan Type

| | NTSC | PAL |
|---|---|---|
| SD | 480i | 576i |
| HD | 480p | 576p |
| | 720p | 720p |
| | 1080i | 1080i |

iInterlaced scan
pProgressive scan

TABLE 2
Frequency (Hz) + Scan Type

| | NTSC | PAL |
|---|---|---|
| SD | 59.94i (≈60i) | 50i |
| HD | 59.94p (≈60p) | 50p |
| | 24p | 24p |
| | 23.976p | 23.976p |

iInterlaced scan
pProgressive scan

### Embodiment 1

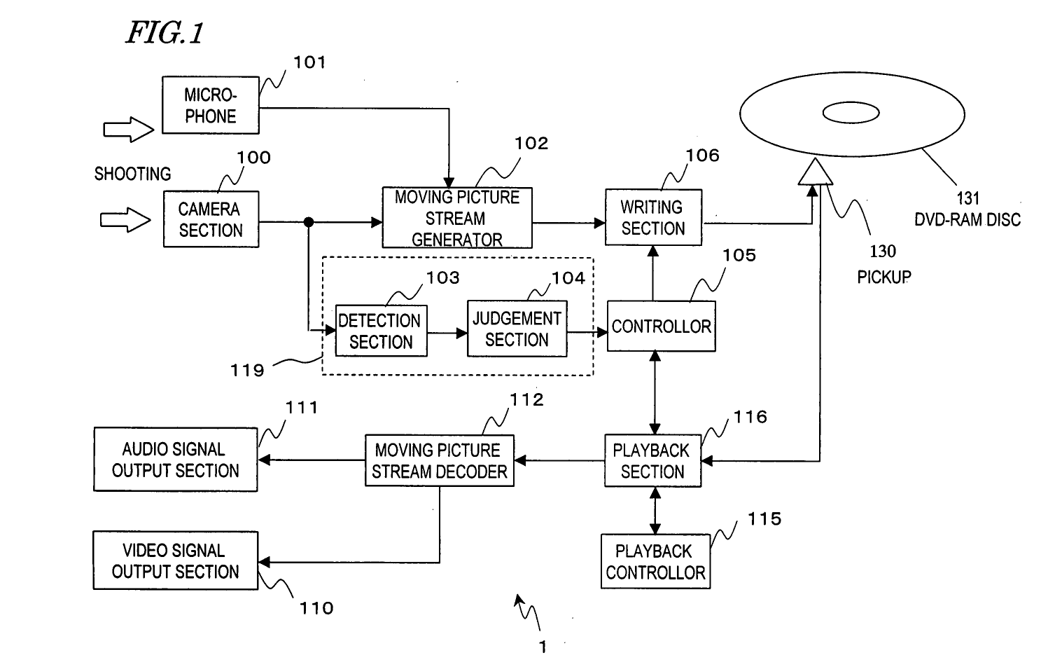

FIG. 1 shows a configuration of the functional block of a video camera 1 according to the present embodiment. The video camera 1 can shoot video to record to a recording medium (DVD-RAM disc 131 in FIG. 1) as HD or SD video. The video camera 1 can also play back video and audio recorded on the recording medium with a built-in monitor or speaker of the video camera 1.

The video camera 1 has a camera section 100, a microphone 101, a moving picture stream generator 102, a controller 105, a writing section 106, a video signal output section 110, an audio signal output section 111, a moving picture stream decoder 112, a playback controller 115, a playback section 116, a video type identification section 119 and a pickup 130. Note that The DVD-RAM disc 131, shown in FIG. 1, is not necessarily a component of the video camera 1. The harddisk or other medium incorporated in the video camera 1 may be a component of the video camera 1 if employed in place of the DVD-RAM disc 131.

Description will be given below of the components of the video camera 1 and then of the operation of the video camera 1.

First, description will be made on the components related to the recording capability of the video camera.

The camera section 100 receives light from a shot target and generates, for example, a digital signal of NTSC interlaced system. That is, the video camera 1 acquires a digital video signal using the camera section 100. The camera section 100 includes, for example, an optical system such as a lens, a CCD element and analog/digital (A/D) converter (not shown). Light received by the camera section 100 includes not only light reflected after striking a person, object, scenery, etc. but also, in the present embodiment, light reflected by the screen after being projected thereonto. That is, the video camera 1 may shoot video such as a cinema movie projected onto the screen as the target. When shooting an ordinary cinema movie which is projected to be shown by switching 24 pictures per second, the camera section 100 shoots the target using a CCD element with shutter speed faster than field frequency 60 Hz (or 1/60 second) in NTSC system. Note that appropriate exposure is preferably obtained with the shutter speed. The camera section 100 outputs an NTSC interlaced video signal in an analog format. A/D converter converts the video signal in the analog format into that of digital format and outputs the signal.

The microphone 101 receives voice being shot and generates an audio signal in the analog format. Microphone 101 is equipped with A/D converter which converts the audio signal in the analog format into that in the digital format and outputs the converted signal.

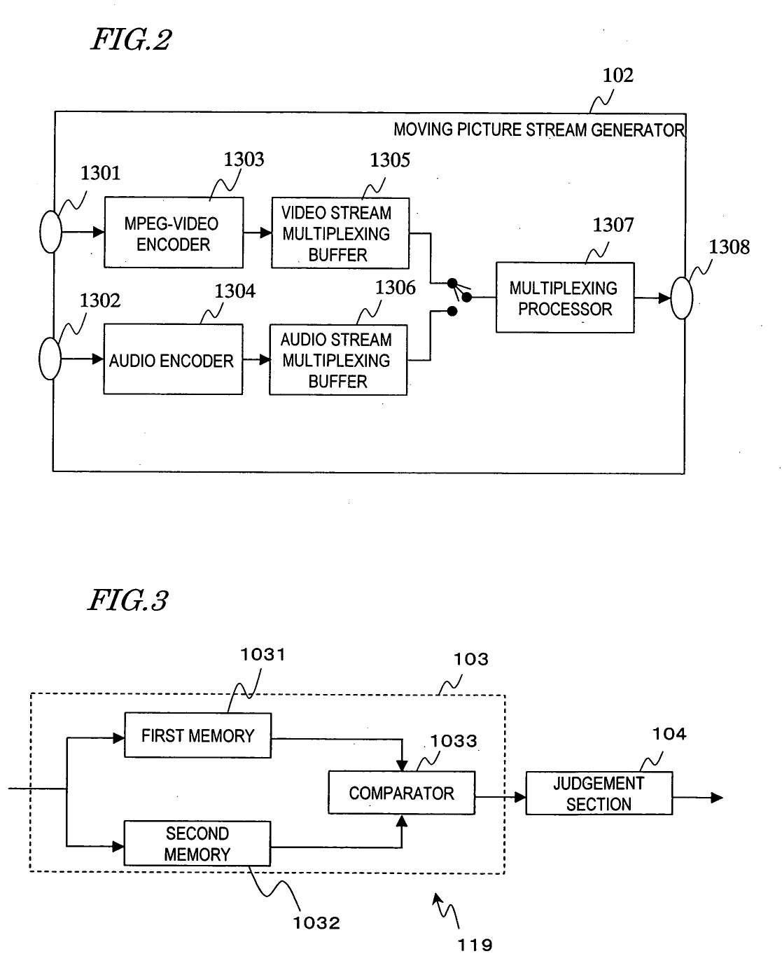

The moving picture stream generator 102 encodes the digital video and audio signals respectively with given encoding systems. FIG. 2 shows a configuration of the functional block of the moving picture stream generator 102. The moving picture stream generator 102 receives the video and audio signals respectively at input terminals 1301 and 1302. An MPEG-Video encoder 1303 generates encoded video data in MPEG-Video format from the video signal. An audio encoder 1304 generates encoded audio data, for example, in AC-3 format from the audio signal. The MPEG-Video encoder 1303 and the audio encoder 1304 generate data in conformity with the recording format. For example, both of the encoders 1303 and 1304 separate the encoded video and audio data into data units corresponding to the recording format, add headers etc. and generate video and audio packets. The video and audio packets are temporarily stored respectively in multiplexing buffers 1305 and 1306. A multiplexing processor 1307 multiplexes the video and audio packets stored in the multiplexing buffers 1305 and 1306, generating an MPEG-2 program stream and outputting the stream through an output terminal 1308.

It is to be noted that, although the moving picture stream is described to contain video and audio data, it is sufficient for the preferred embodiment that at least the video data is contained in the moving picture stream. The MPEG-2 program stream is an example of system stream defined by the MPEG2 System Standard (ISO/IEC 13818-1). In this system stream, transport stream (TS) and PES stream are defined in addition to program stream (PS). The present invention is applicable even if the moving picture stream is an MPEG-2 transport stream. In the present embodiment, the data structures of these streams are not specifically important, and description thereof is omitted herein.

Description will be given next of the video type identification section 119 with reference to FIG. 3. FIG. 3 shows a configuration of the functional block of the video type identification section 119. The video type identification section 119 receives a video signal from the camera section 100 and identifies a type of the video. The “type of the video” is determined in accordance with picture counts of the video displayed per unit time (one second). In this preferred embodiment, the types of the video are classified into, for example, cinema movies switched at the rate of 24 pictures per second, and television broadcasting switched at the rate of 30 pictures (i.e. 30 frames/60 fields) per second.

The video type identification section 119 has a detection section 103 and a judgement section 104. The detection section 103 includes first and second memories 1031 and 1032 and a comparator 1033.

Video signal input to the detection section 103 is received by the first and second memories 1031 and 1032 and stored therein. Each of the two memories 1031 and 1032 stores data of a picture. For example, assuming that one picture is constructed by two field images, the memory 1031 stores data of one field image and the memory 1032 stores the other field image. The comparator 1033 compares, at a display time interval of one-field image (approx. 1/60 second), the stored contents in the first and second memories 1031 and 1032 and outputs a comparison result. The comparison is performed by calculating difference between the stored content of the first memory 1031 and that of the second memory 1032. The comparison result is output, which indicates whether the difference is 0 or not, that is, the respective stored content in the memories 1031 and 1032 make a match or a mismatch. In the case where the video signal contain noise, the difference may be calculated after the noise is removed using such as a digital filter.

As for a progressive-scanned video, the first and second memories 1031 and 1032 may store each data of frame images, since one picture corresponds to one frame image. In the case where a progressive-scanning type camera is used, the progressive-scanned video signal is output. Based on the signal, the first and second memories 1031 and 1032 store data of progressive-scanned frame images at the rate of 60 frames per second which are used for comparing the difference.

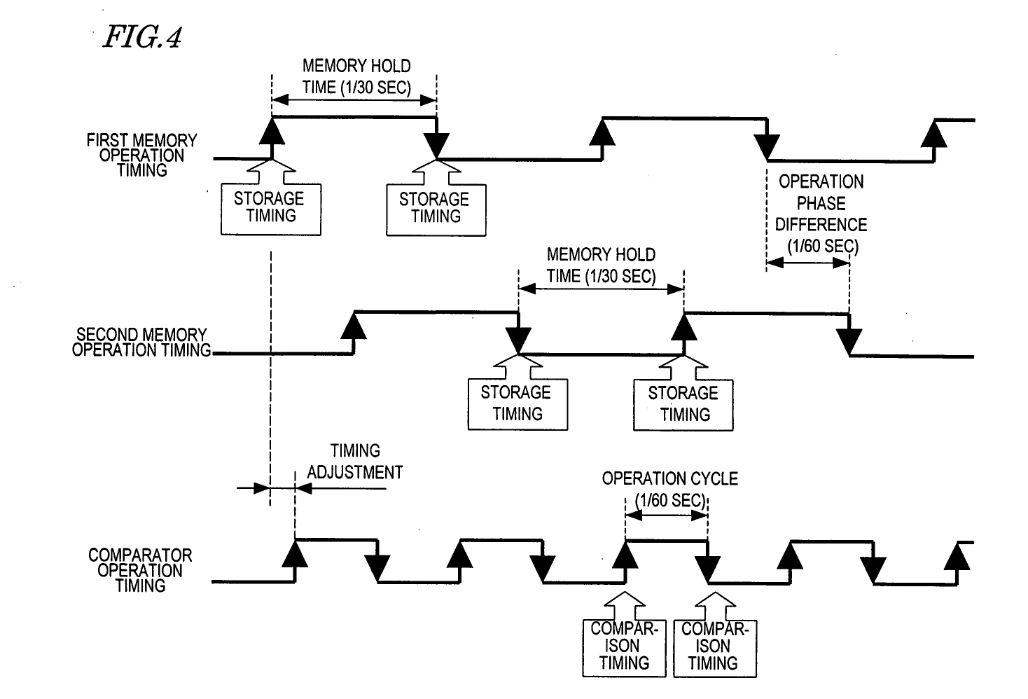

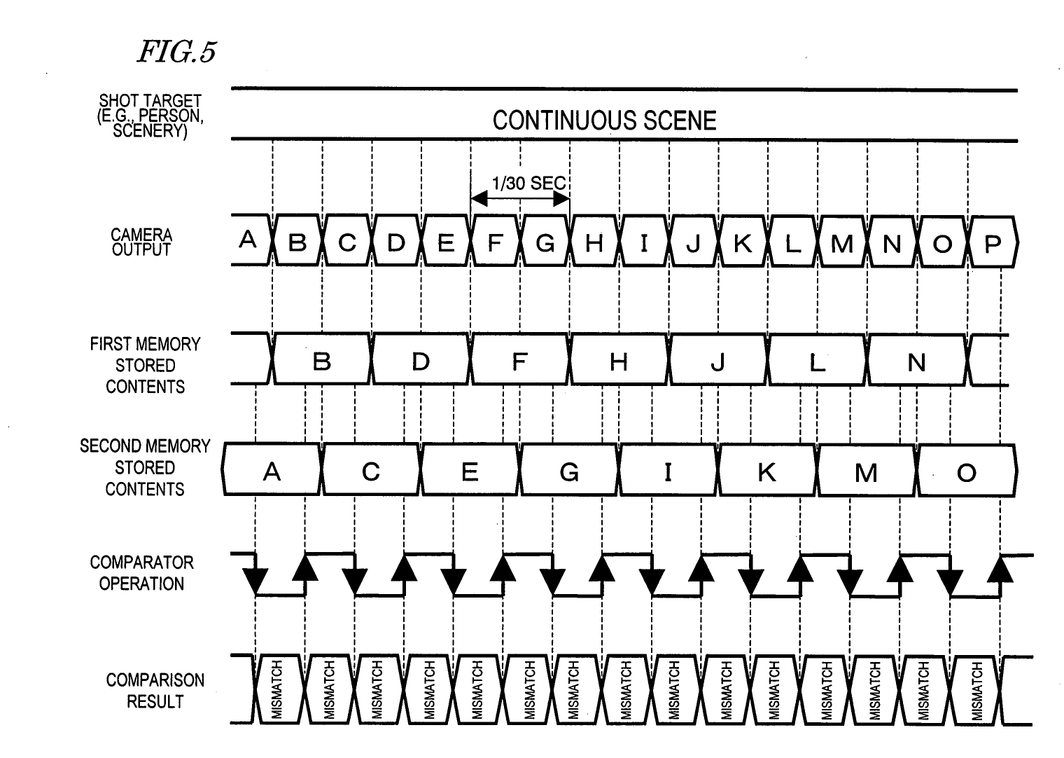

FIG. 4 shows an example of the operation timing of each of the functional blocks of the detection section 103. When an NTSC interlaced system video signal is input, two pieces of field image data, an odd and an even line making up that picture, are stored respectively in the memories 1031 and 1032. The memories 1031 and 1032 update the stored contents in the same cycle as the frame count per second (approx. 30 frames per second), as indicated by “Storage timing.” The memories 1031 and 1032 perform the updating operations while maintaining a phase difference (timing deviation) of one field (approx. 1/60 second) with each other. The comparator 1033 makes a comparison at the time periods indicated as “Comparison timing” where leading and trailing edges of the clock occur in 60 Hz. The comparison timing comes per 1/60 second and arrives after the updating is complete of the stored contents of the memories 1031 and 1032. The comparator 1033 outputs the result until the next “Comparison timing.”

In FIG. 4, the comparator 1033 carries out a comparison following the storage operation of each of the memories 1031 and 1032 and after going through the time period indicated as “Timing adjustment.” The comparator 1033 outputs a value indicating “0” when the result of comparison is a “match” and a value indicating “1” if the result of comparison is an “mismatch.”

FIG. 5 shows the process performed in the video camera 1 when a person, scenery or other target is shot by the video camera 1. As a result of continuous shooting of video, a video signal of NTSC interlaced field images A, B, C and so on is output from the camera section 100. At this time, the first memory 1031 stores the data of the even-field images B, D, F and so on. The second memory 1032 stores the data of the odd-field images A, C, E and so forth. The comparator 1033 makes a comparison at the leading and trailing edges of the pulse. In the case shown in FIG. 5, the storage timings of the first and second memories 1031 and 1032 are apart by the time of one field image, thus preventing the two memories from storing the same data at the same time. This leads to all the outputs of the comparator 1033 being an mismatch.

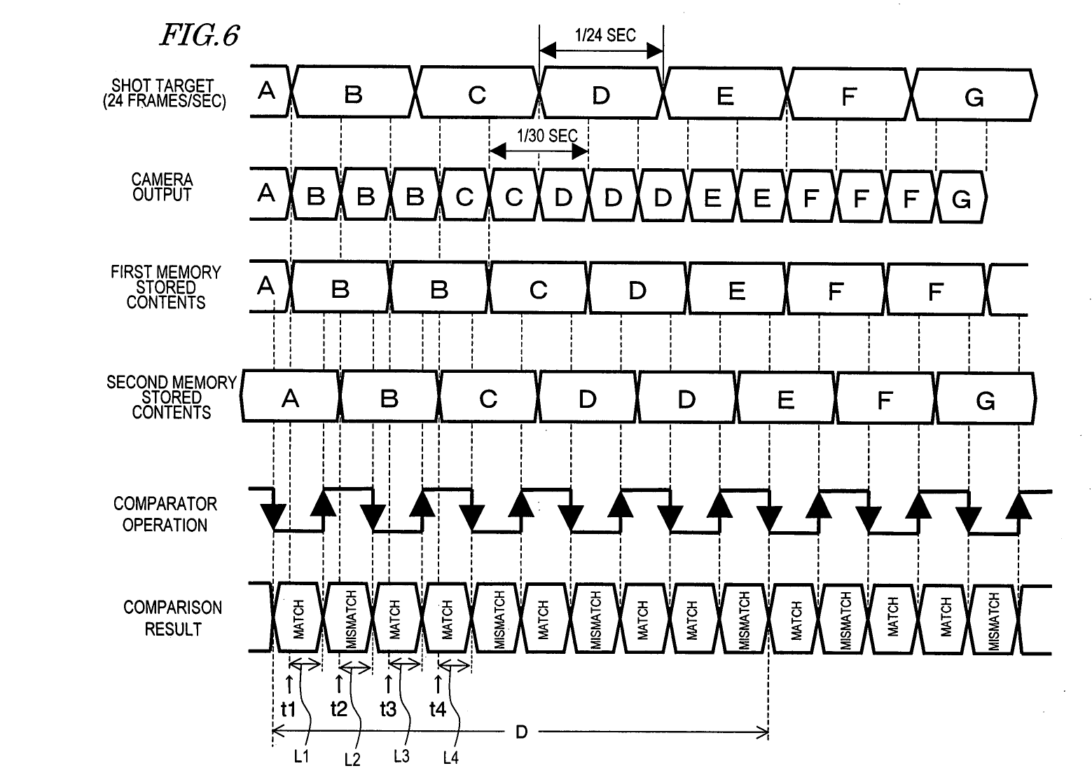

FIG. 6 shows the process performed in the video camera 1 when a cinema movie projected onto the screen is mainly shot by the video camera 1. Since images A, B, C and so on of each of the pictures (frames) making up the cinema movie are switched every 1/24 second, the CCD element of the camera section 100 generates a video signal of the field image consisting of A, B, B, B, C, C, D, D, D and so on at the interval of 1/60 second. As a result, at the transition time from “frame A” to “frame B” (time t1), for example, the stored contents of the first memory 1031 are updated to the “frame B” data. At this time, the “frame A” data is already stored in the second memory 1032.

When a given period L1 elapses after the updating operation of the first memory 1031, the comparator 1033 proceeds with the comparison operation. At this time, the stored contents of the first and second memories are respectively “frame B” and “frame A”, thus leading to the comparison result being an “mismatch.” The comparison result is hold until a next comparison is carried out.

At a time t2, approximately 1/60 second after the time t1, the second memory 1032 stores the frame B data. At this point in time, the “frame B” data is stored in both the first and second memories 1031 and 1032. Therefore, the comparison result of the comparator 1033 at the pulse trailing edge after a lapse of period L2 from the time t2 is a “match.”

At a time t3, approximately 1/60 second after the time t2, since the frame B video signal continues to be output from the camera section 100, the first memory 1031 stores the “frame B” data again and the second memory 1032 also has the “frame B” data stored therein. Since the stored contents in the memories 1031 and 1032 are not changed at the comparison timing after a lapse of period L3 from the time t3, the comparison result is a “match.”

On the other hand, the shot target changes from the “frame B” to the “frame C” in 1/24 second after the time t1. Later at a time t4 (1/60 second after the time t3), therefore, the “frame C” data is stored in the second memory 1032. The comparison result is an “mismatch” because the first memory 1031 has the “frame B” stored therein whereas the second memory 1032 has the “frame C” data stored therein at the comparison timing after a lapse of period L4 from the time t4.

Thereafter, the stored contents of the memories 1031 and 1032 are updated in succession, producing, as a result of the comparisons, a comparison result in which “match” and “mismatch” are repeated in a constant order in a cycle D.

The detection section 103 repeats the above-described comparisons and outputs respective comparison results.

The judgement section 104 of the video type identification section 119 continuously receives the comparison results from the detection section 103, and judges whether a pattern obtained from a series of “match” and “mismatch” coincide with a specified pattern or not. The “specified pattern” appears in the case where the shot target is 24-picture-per-second video (i.e. cinema movie). In this preferred embodiment, the “specified pattern” is shown in FIG. 6 as the pattern defined by the output results of “match” and “mismatch” in period D. The specified pattern can be obtained before shipment of the video camera 1 by actually shooting 24-picture-per-second video such as a projected cinema movie. A data representing the specified pattern is stored, for example, in a read-only memory (not shown) of the judgement section 104.

The judgement section 104 judges that the shot target is not the 24-picture-per-second video or a cinema movie, when “mismatch” continues in the comparison result of the detection section 103 as shown in FIG. 5. On the other hand, the judgement section 104 judges that the shot target is the 24-picture-per-second video if match and mismatch of the comparison result are repeated and appears in the order shown in the cycle D of FIG. 6. The judgement section 104 outputs, as an output result, a value indicating the count per second (e.g., “24”) of displayed pictures or a flag value indicating whether the shot target is a cinema movie, thereby the type of the video (i.e. shot target) is determined.

Note that, in FIG. 6, a switching timing of the picture B of the video shot target coincides with a switching timing of the output of the camera. This condition is adopted for the sake of convenience of the explanation. The above explanation may be adopted in a similar fashion, even if these timings do not coincide with each other.

Referring back to FIG. 1, the controller 105 determines whether to enable or disable the writing of the moving picture stream on the DVD-RAM disc 131 based on the output of the judgement section 104 and instructs the writing section 106. More specifically, when the judgement result output from the judgement section 104 indicates a cinema movie, the controller 105 determines to disable the writing of the moving picture stream by judging that the shot target is a cinema movie. In any other cases, the writing of the moving picture stream is enabled. The reason for disabling the writing of the moving picture stream is to protect the copyright of the cinema movie by disabling the writing of the moving picture stream, an act equivalent to copying of the cinema movie, because cinema movies generally involve one or more copyrights to be protected.

The writing section 106 controls the writing of the moving picture stream on the DVD-RAM disc 131 based on the decision made by the controller 105. More specifically, the writing section 106 does not write the moving picture stream if the writing of the moving picture stream is disabled by the controller 105. When the writing is not disabled, the writing section 106 writes the file to the DVD-RAM disc 131 via the pickup 130. The written moving picture stream is managed as a chronological data file on the file system. It is to be noted that the moving picture stream is also referred to as chronological data.

Description will be given next of the components related to the playback capability of the video camera 1.

The playback controller 115 instructs the readout of the user-specified chronological data file, a moving picture stream. The playback section 116 manipulates the pickup 130, optically reading out the chronological data file specified by the playback controller 115 and acquiring the file as the moving picture stream. The moving picture stream decoder 112 separates video and audio data respectively from the moving picture stream for decoding, thus generating video and audio signals. The resolution of the decoded video is the same as the resolution at the time of the encoding or less. The video signal output section 110 is, for example, an liquid crystal display (LCD) device (not shown) and changes pictures one after another based on the video signal, thus playing back the video. The audio signal output section 111 is, for example, a speaker and plays back the audio signal as sounds. It is to be noted that the video camera 1 can output the chronological data file played back from the DVD-RAM disc 131 to external equipment via a digital interface (not shown) compliant with a standard such as the IEEE1394 Standard.

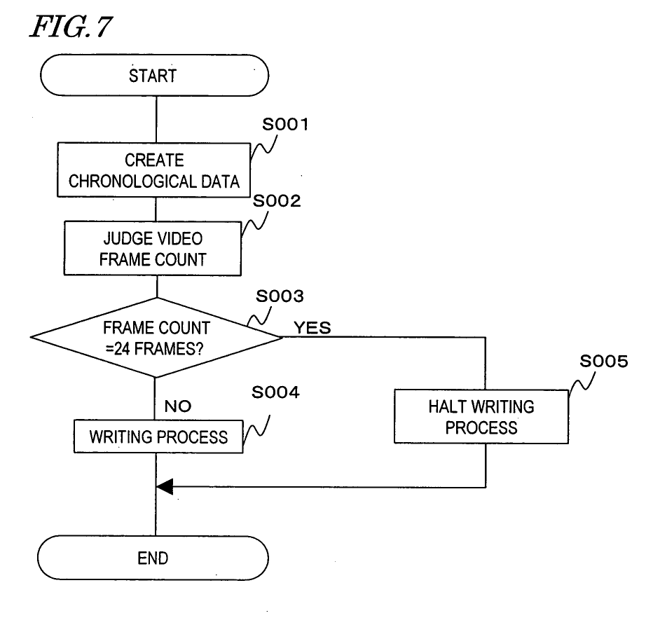

Description will be given next of the recording process of the video camera 1. FIG. 7 shows the steps of the recording process of the video camera 1 according to the present embodiment. Note that, in the following explanation, the judgement section 104 outputs a value indicating the count per second (i.e., “24”) of displayed pictures.

First in step S001, the video camera 1 generates chronological data or a moving picture stream. The chronological data is generated as the camera section 100 and the microphone 101 output video and audio signals, and as the moving picture stream generator 102 encodes these signals.

In step S002, the detection section 103 and the judgement section 104 of the video type identification section 119 judge the video picture count (frame count) per second of the subject based on the video signal output from the camera section 100.

In step S003, the controller 105 judges whether the video frame count is 24 frames per second. If the frame count is not 24 frames per second, the process proceeds to step S004. When the frame count is 24 frames per second, the process proceeds to step S005.

In step S004, the controller 105 enables the writing of the moving picture stream. In response to enabling of the writing, the writing section 106 writes the moving picture stream to the DVD-RAM disc 131. In step S005, on the other hand, the controller 105 disables the writing of the moving picture stream by judging the shot target as being a cinema movie. As a result, the writing section 106 halts the writing. The process ends following step S004 or S005.

When a subject other than a cinema movie (e.g., a person or scenery described in relation to FIG. 5) is chosen as the target to be shot, the subject's motion in some likelihood may remain almost unchanged. In such a condition, substantially the same image data is input to the first and second memories 1031 and 1032, resulting in a “match” being repeated as the comparison result of the comparator 1033. For this reason, the judgement section 104 may judge that the video is 24 frames a second when the comparison result repeats a pattern with the cycle D as shown in FIG. 7, and may judge that the video is not 24 frames a second in any other cases, i.e., if “mismatch”s are repeated, “match”s are repeated, or if “mismatch”s and “match”s appear in a pattern different from the above-described pattern with the cycle D (unspecific pattern).

### Embodiment 2

The video camera according to the embodiment 1 disables the writing of the moving picture stream if the shot target is 24-picture-per-second video.

The video camera according to the present embodiment writes the moving picture stream at a lowered video quality if the shot target is 24-picture-per-second video.

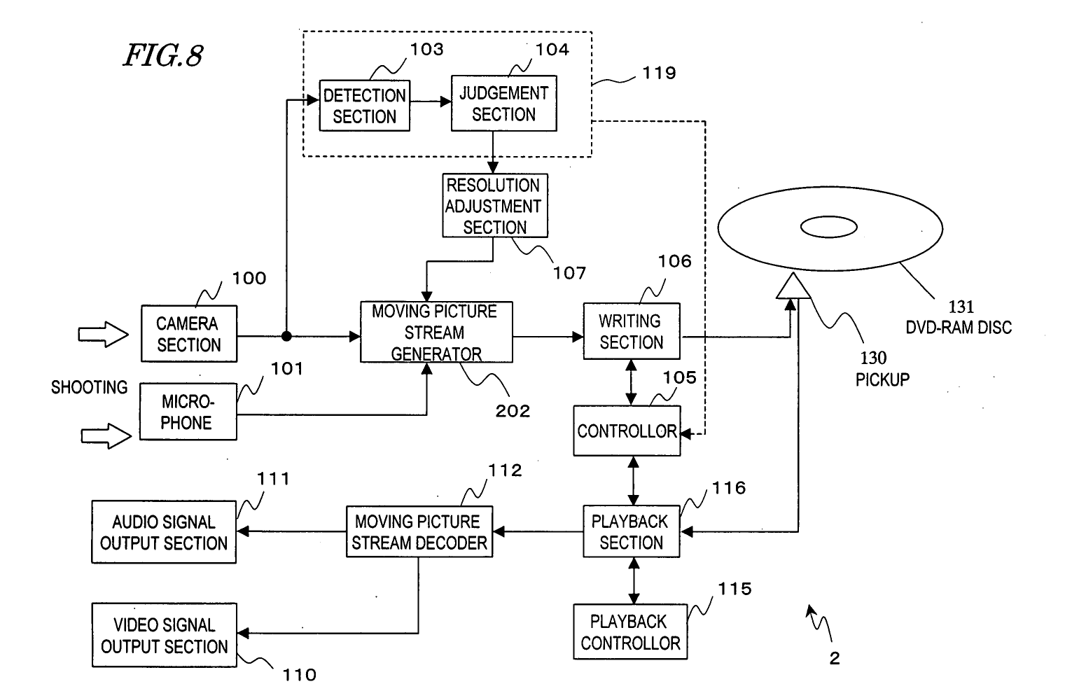

FIG. 8 shows a configuration of the functional block of a video camera 2 according to the present embodiment. The components common to the video cameras 2 and 1 (FIG. 1) are assigned common reference symbols. We assume that, unless otherwise mentioned below, the capabilities and operation of the components of the video camera 2 are the same as those of the components described in FIG. 1 that are assigned the same symbols.

The video camera 2 is provided with a resolution adjustment section 107 that receives the output of the video type identification section 119 and adjusts the video resolution based on the output. The resolution adjustment section 107 selects a resolution lower than that set during the shooting by the user when the type of the video identified by the video type identification section 119 is a cinema movie. For example, if the video camera 2 is set up by the user to perform the recording at the NTSC system's 1080i video quality (HD image quality) and if the video picture count is identified as 24 pictures per second, the resolution adjustment section 107 selects a resolution such that the recording is performed at the NTSC system's 480i (SD quality). On the other hand, the resolution adjustment section 107 selects the same resolution as is set in advance during the shooting if the type of the video is not a cinema movie, thereby the resolution is preserved. The resolution adjustment section 107 notifies the selected resolution to a moving picture stream generator 202.

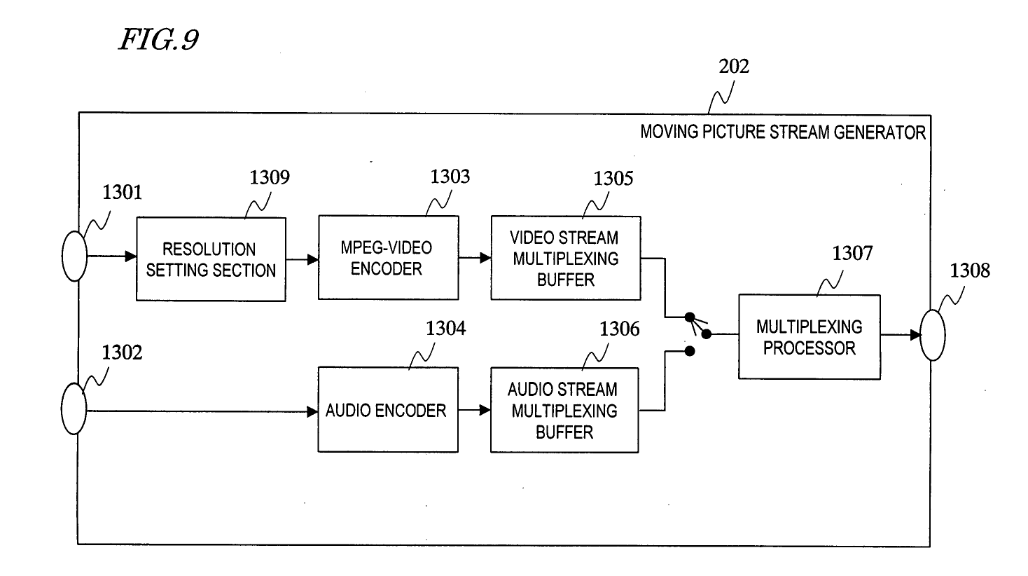

FIG. 9 shows a configuration of the functional block of the moving picture stream generator 202. The moving picture stream generator 202 is configured by adding the configuration of a resolution setting section 1309 to the moving picture stream generator 102 shown in FIG. 5. The resolution setting section 1309 is provided between the input terminal 1301 and the MPEG-Video encoder 1303. The resolution setting section 1309 sets an encoding parameter corresponding to the resolution instructed by the resolution adjustment section 107. The MPEG-Video encoder 1303 encodes the video using the parameter.

When a moving picture stream is generated, the writing section 106 writes the moving picture stream to the DVD-RAM disc 131. Note that the controller 105 enables the writing of the moving picture stream to the writing section 106. In the present embodiment, the controller 105 does not disable the writing.

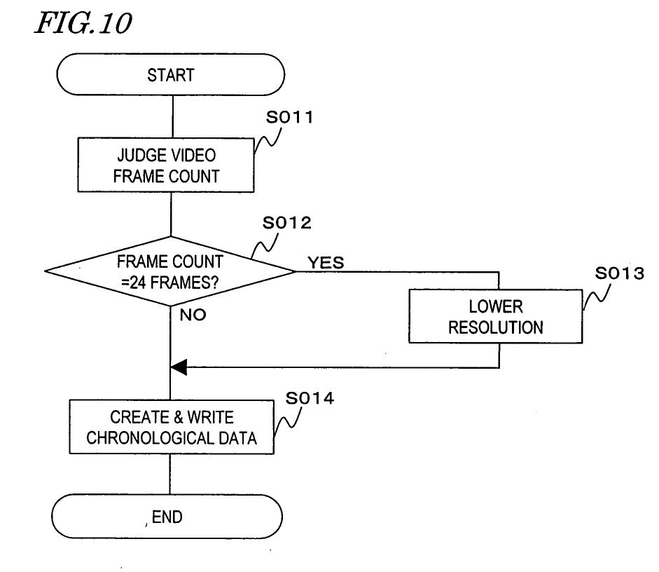

FIG. 10 shows the steps of the recording process of the video camera 2 according to the present embodiment. The process in step S011 is the same as the step in step S002 in FIG. 7. That is, the video type identification section 119 judges the video picture count (frame count) per second of the subject based on the principle described in the embodiment 1.

In step S012, the resolution adjustment section 107 judges whether the video frame count is 24 frames per second. If the frame count is not 24 frames per second, the process proceeds to step S013. When the frame count is 24 frames per second, the process proceeds to step S014. In step S013, the resolution adjustment section 107 selects a resolution lower than that set by the user in advance.

In step S014, the moving picture stream generator 202 performs the encoding at the selected resolution, generating chronological data (moving picture stream). When the process branches from step S012, the user-specified resolution will be employed. The controller 105 determines to enable the writing of the moving picture stream, and in response to enabling of the writing, the writing section 106 writes the chronological data file of the moving picture stream to the DVD-RAM disc 131 via the pickup 130.

The above process allows the video camera 2 to write the moving picture stream at a lowered video quality if the shot target is cinema movie, thus protecting the copyright of the cinema movie.

It is to be noted that in the above description, if the shot target is judged as being a cinema movie based on the picture count (frame count) per second, the resolution adjustment section 107 lowers the resolution during the encoding. The resolution adjustment section 107 can arbitrarily select a resolution from the range shown in the above-described Table 1. However, an arbitrary resolution may be employed as long as the resolution falls within the range compliant with the video standard. The moving picture stream is played back in conformity with the resolution at the time of the encoding.

Attention can be called to the copyright infringement during later distribution and the copyright protected by lowering the faithfulness to the shot target, for example, through the recording with a message superimposed on the video signal, through the recording after mosaicing the video, through the recording at a lowered frame rate (picture count per second) (e.g., 5 pictures per second), or through the recording of a black screen, in addition to the lowered resolution.

### Embodiment 3

The video camera according to the present embodiment identifies a type of the video of the shot target, sets a resolution at the time of the encoding and, if the encoding is performed at a lowered resolution, generates information (judgement_information) indicating this fact, and writes the information together with the moving picture stream to the recording medium.

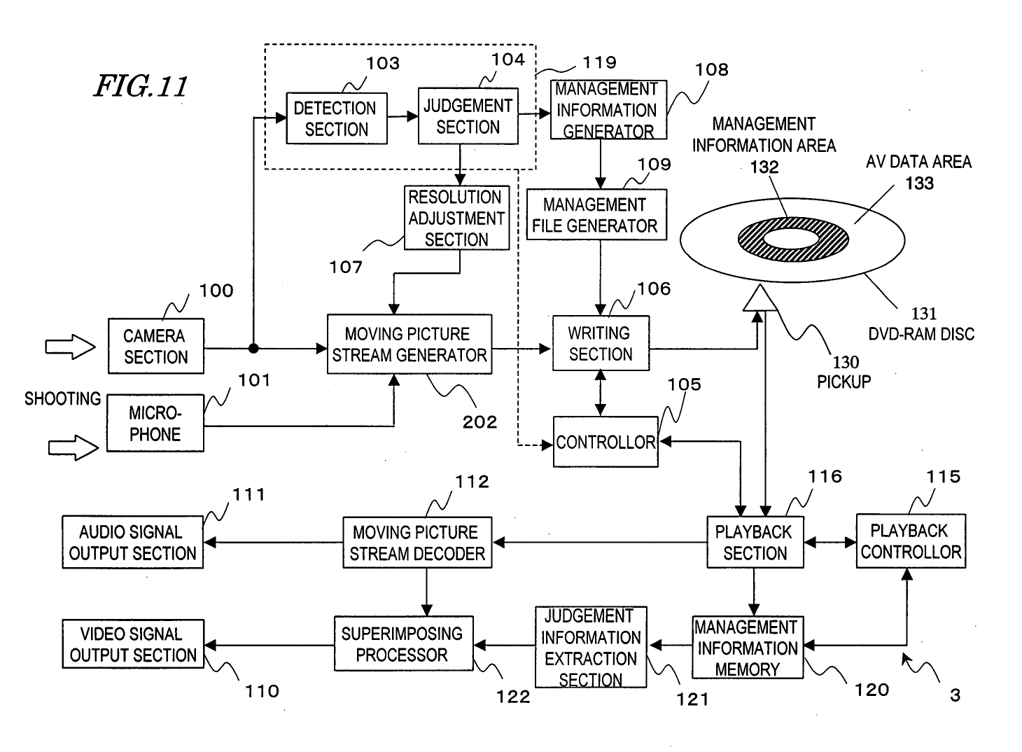

FIG. 11 shows a configuration of the functional block of a video camera 3 according to the present embodiment. The video camera 3 is configured by newly adding a management information generator 108, a management file generator 109, a management information memory 120, a judgement information extraction section 121, and a superimposing processor 122 to the video camera 2 according to the embodiment 2. Other components are the same. It is to be noted that in the DVD-RAM disc 131, a management information area 132 which storing the management information, and an AV data area 133 which stores the moving picture stream are defined. Description will be given below of the video camera 3 in relation to the aforementioned differences.

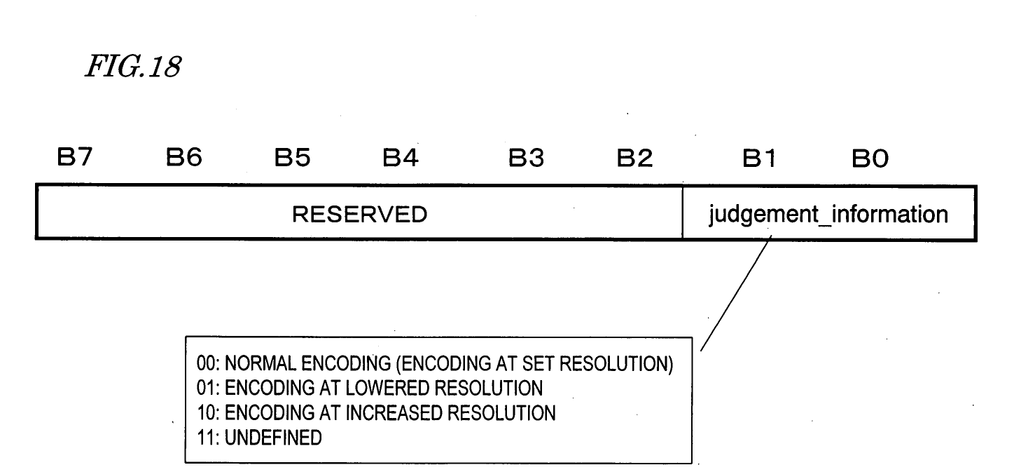

First, when the video signal is encoded at a resolution lower than that set at the time of the shooting by the moving picture stream generator 202, the management information generator 108 generates judgement information indicating the fact. Details of the judgement information will be described later with reference to FIG. 18.

The management file generator 109 generates a management file containing the judgement information which is generated by the management information generator 108.

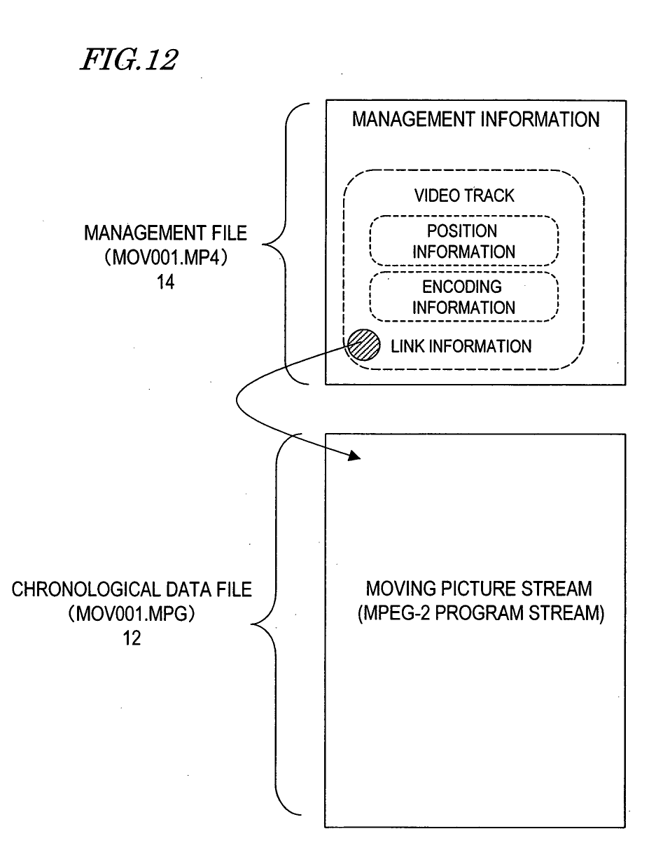

Here, the management file will be described referring to FIG. 12. In this preferred embodiment, data structure of the management file is provided to comply with a known MP4 file format. Specific data of this embodiment which are stored in the above-mentioned data structure are explained later.

FIG. 12 shows the relationship between a chronological data file 12 and a management file 14 according to the present embodiment. The management file 14 stores management information and is under the file name called “MOV001.MP4.” On the other hand, the chronological data file 12 stores a moving picture stream and is under the file name called “MOV001.MPG.” In the present embodiment, we assume that the moving picture stream is an MPEG-2 program stream.

The management information stores the information for managing the playback of the moving picture stream video stored in the chronological data file 12. With the management information, the video-related information is managed in units called “video tracks.” The video tracks include position information for each access unit (access information) and encoding information. In the present embodiment, the judgement information makes up part of the encoding information and is stored in the management information. These pieces of information, generated during the writing of the moving picture stream, are used for random access at the time of the playback of the moving picture stream. The management information also includes link information for identifying the corresponding moving picture stream. The link information is, for example, the file name (“MOV001.MPG”) of the chronological data file storing the corresponding moving picture stream.

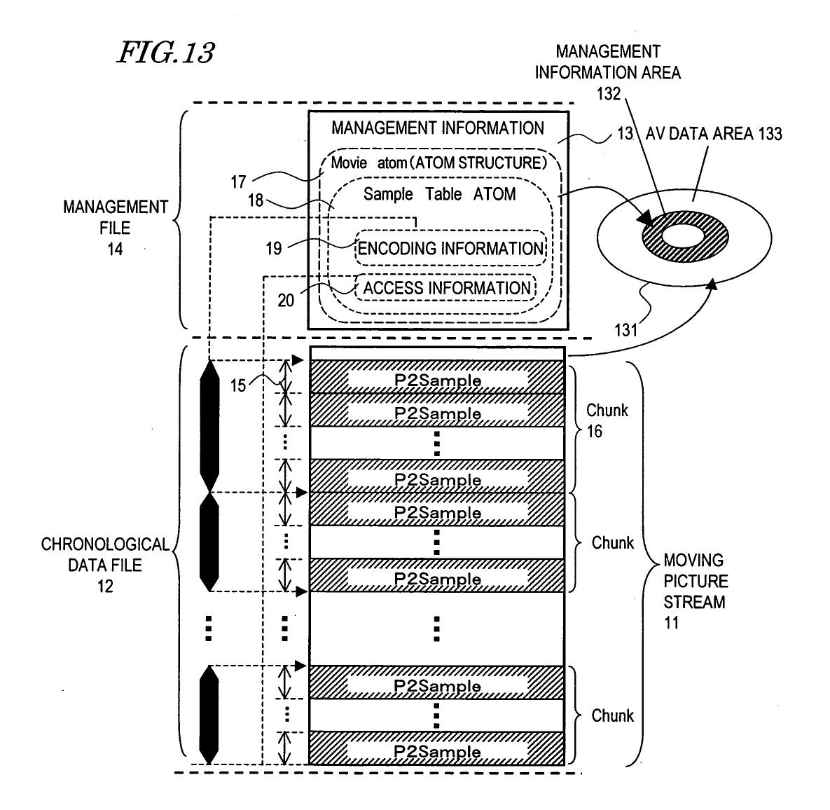

FIG. 13 shows the data structures of the chronological data file 12 and the management file 14 written on the optical disc 131. The chronological data file 12 includes a moving picture stream 11, whereas the management file 14 includes management information 13. The chronological data file 12 is written to the AV data area 133 of the optical disc 131, whereas the management file 14 is written to the management information area 132 of the optical disc 131.

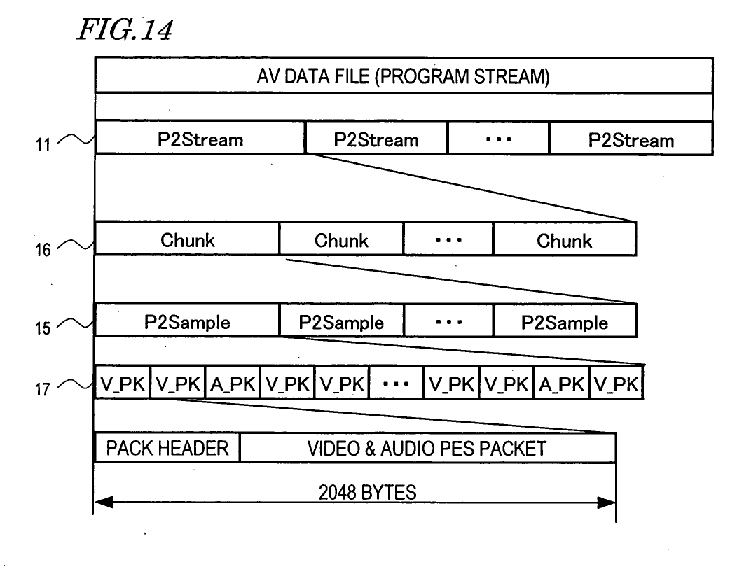

The moving picture stream 11 includes a plurality of samples (P2 Sample) 15. The samples 15 includes video and audio data mixed together. The samples 15 can be defined based on the video playback time, the data size (data volume) and other factors, and includes video data of 0.4 to one second in video playback time such as a DVD video object unit (VOBU). A set of one or more of the samples 15 is called a chunk 16. FIG. 14 shows the detailed data structure of the moving picture stream 11. Each of the samples 15 includes a plurality of video packs (V_PK) and audio packs (A_PK). Each pack, includes a PES packet storing a pack header and video or audio data, is constant in data volume (2048 bytes). For the moving picture stream as shown in FIG. 14, video data and audio data may be combined as a moving picture stream track and managed globally as a single track.

Referring back to FIG. 13, the management information 13 includes sample-by-sample access information 20 and encoding information 19. These pieces of information, managed using the data structure called the atom structure, are more specifically recited within a sample table atom (sample Table ATOM) 18 within a movie atom (Movie atom) 17. The samples are managed as the smallest management units in the sample table atom (Sample Description Atom) 18, with the access information 20 indicating the data storage location and other information written to each of the samples. The encoding information 19 is defined sample by sample or chunk by chunk and applied commonly to the video data in each unit—sample or chunk. It is to be noted that each of the samples 15 and the chunks 16 is a unit of the moving picture stream 11 managed by the management information 13, and the data of the moving picture stream 11 is not always defined through physical classification.

Description will be given next of the type of criterion used in the management information 13 to define the samples 15 and the chunks 16. We assume, for example, that the video and audio data having approximately 0.4 to one second in video playback time is dealt as the one sample (P2 Sample) 15. The access information for each of the samples is written to the management information 13. Then, once a resolution is determined that is commonly applied to a series of video, the section corresponding to these pieces of video is handled as the single chunk 16, with the encoding information 19—information common to the samples in each of the chunks—defined. Among examples of “a series of video” are pieces of video shot by the video camera that are continuous from start to end of the recording. The access information for each of the chunks can be set in the management information 13. It is to be noted that although the section of a series of video with a common resolution has been descried as the criterion for defining the chunks, the chunks may be defined based on other criterion not particularly relevant to the present invention.

The moving picture stream generator 202 and the management information generator 108 generate the moving picture stream 11 and the management information 13 based on the above-described data structures and criterion.

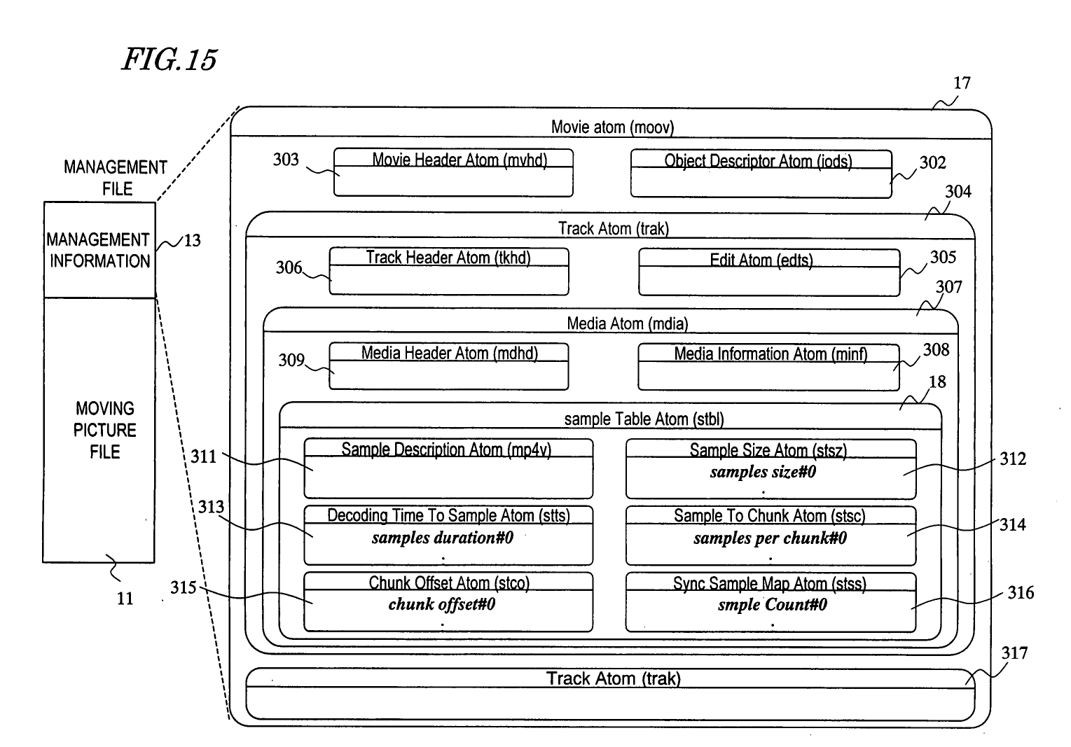

FIG. 15 shows the atom structure of the management information 13 of the moving picture file (MPEG2-PS) shown in FIG. 14. The management information 13 is defined in the movie atom 17. In the movie atom 17, information such as the independent frame-by-frame data size, the data storage destination address and the time stamp indicating the playback timing is written for each piece of encoded video and audio data. For the video data, a track atom 304 is defined. Of various atoms 305, 306, 307 and so on within the track atom 304, a sample table atom 18 within the media atom 307 will be described in the present specification. The media atom 307 is a field for storing information related to encoded stream. It is to be noted that for the audio data, a track atom 317 is, for example, defined.

The sample table atom 18 further has a plurality of atom fields 311 to 316. Of these fields, attention is focused on the sample description atom 311, the sample size atom 312, the decoding time to sample atom 313, the sample to chunk atom 314 and the chunk offset atom 315.

In the sample description atom 311, the encoding information applied to the video within that sample is defined. In the sample size atom 312, the data size of that sample is defined. In the decoding time to sample atom 313, the video playback time of that sample is defined. In the sample to chunk atom 314, the number of samples included in a chunk is defined. In the chunk offset atom 315, the top position (offset) of each of the chunks is defined that is calculated, for example, from the top of the chronological data file. It is to be noted that “#0” written in the atoms 312 to 315 indicates that the data is for the 0th sample or chunk and followed by the first, second and succeeding pieces of data that are not shown.

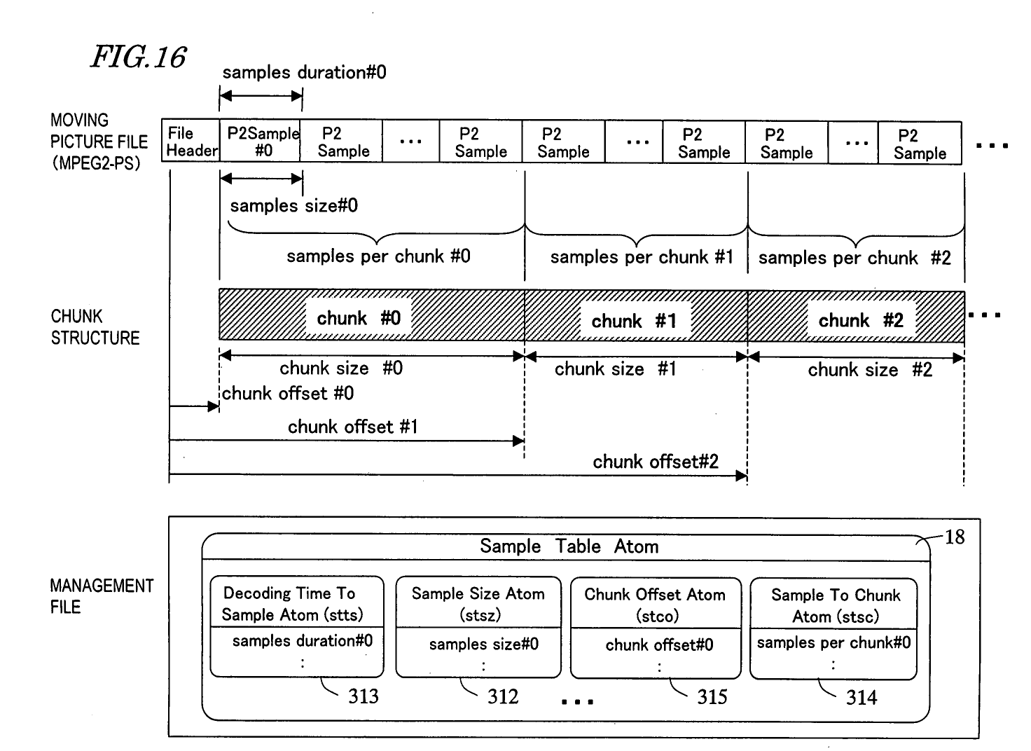

FIG. 16 shows the stream data units in the moving picture file, the chunk structure and the atom (sample table atom) 18 within the management file corresponding to the moving picture file. The fields within the atoms 312 to 315 in the sample table atom) 18 define the data size, the playback time and so on corresponding to the section under the same name shown in the stream data units in the moving picture file and the chunk structure. For example, “samples size#0” shown in the sample size atom 312 defines the data size of the P2 sample arranged at the beginning (0th position) of the chronological data file 12. As shown in FIG. 16, the samples, the chunks and others making up the chronological data file 12 are defined in the sample table atom 18 within the management file.

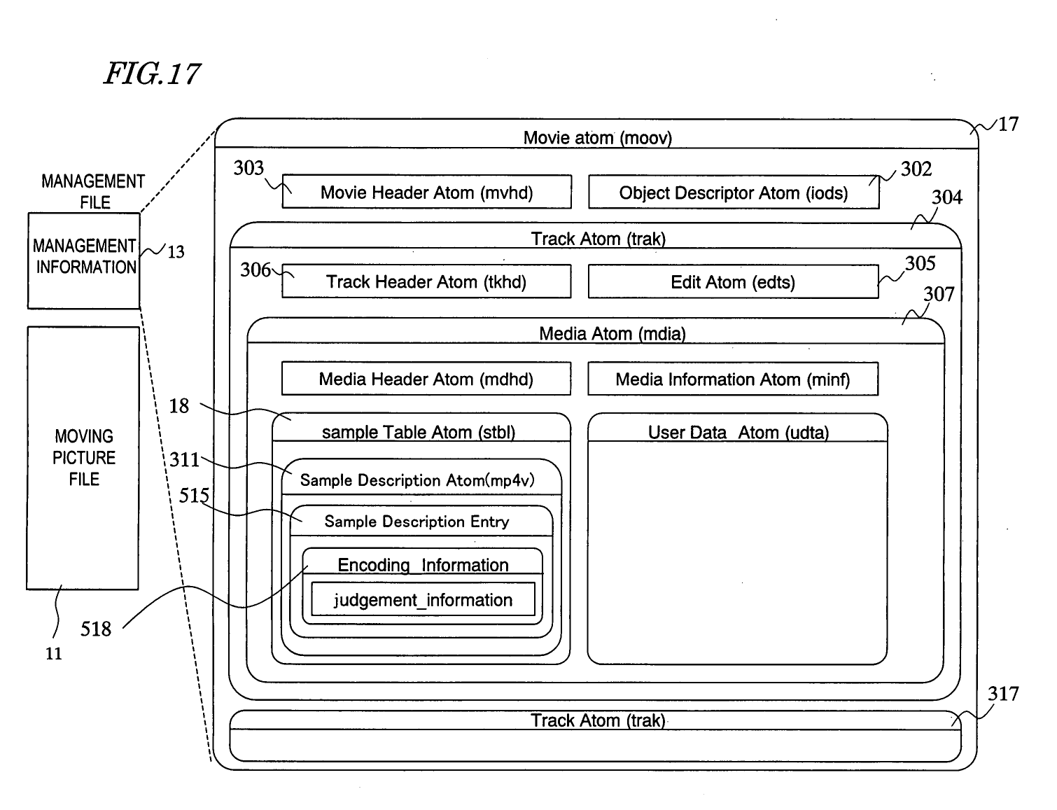

FIG. 17 shows in more detail the atom structure of a sample description atom 311 of a sample table atom 18. The sample description atom 311 includes one or more sample description entries 515. The sample description entry 515 is provided for each of the chunks. Further, the sample description entry 515 includes encoding information 518. judgement information (judgement_information) indicating whether or not the video is encoded with lower resolution, is described as part of the encoding information 518.

FIG. 18 shows the data structure of the encoding information 518. The encoding information is defined by eight bits. Of the eight bits, the lower two bits (B0 to B1: judgement_information) define the judgement information. The upper six bits are reserved bits. The judgement information defines at least four types of information using the two bits. More specifically, relative to the resolution set at the time of the shooting, “00” represents that the video was encoded at that resolution, whereas “01” indicates that the video was encoded at a resolution lower than that resolution. Further, in the present embodiment, “10” is defined to represent that the video was encoded at a resolution higher than that resolution. It is to be noted that the meaning of “11” is undefined.

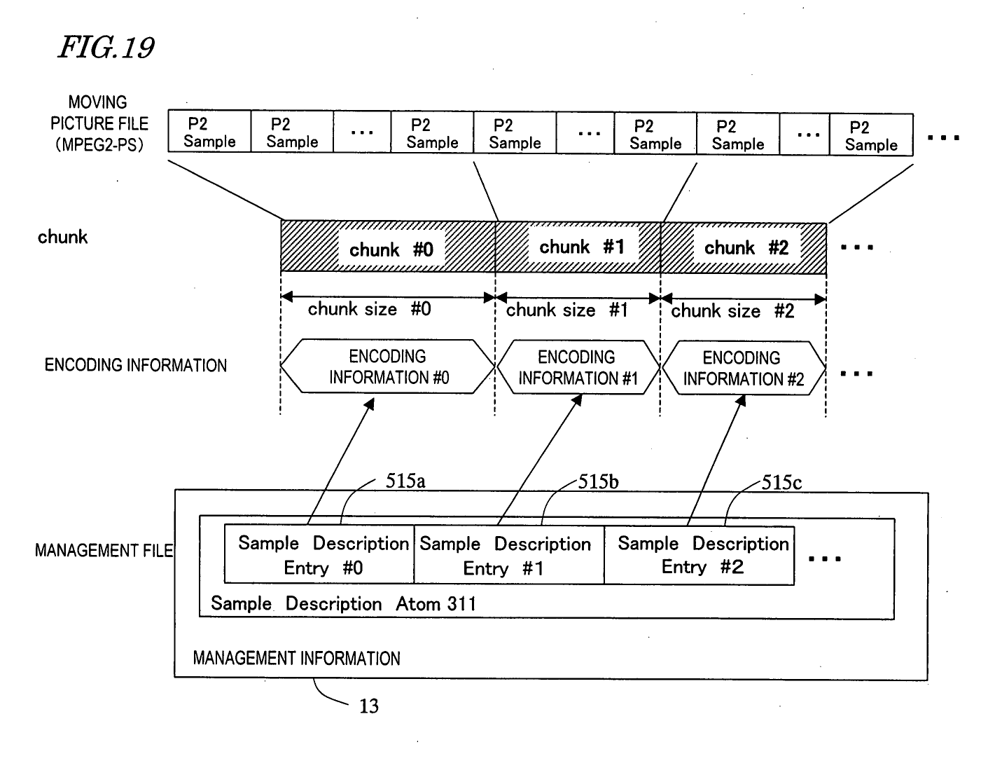

FIG. 19 shows the range to which each piece of the judgement information is applied and sample description entries #0 to #3 to which each piece of the judgement information is written. As shown in FIG. 18, since the judgement information #n (n: integer) is applied to a chunk #n, the judgement information #n is commonly applied to the video within the chunk #n.

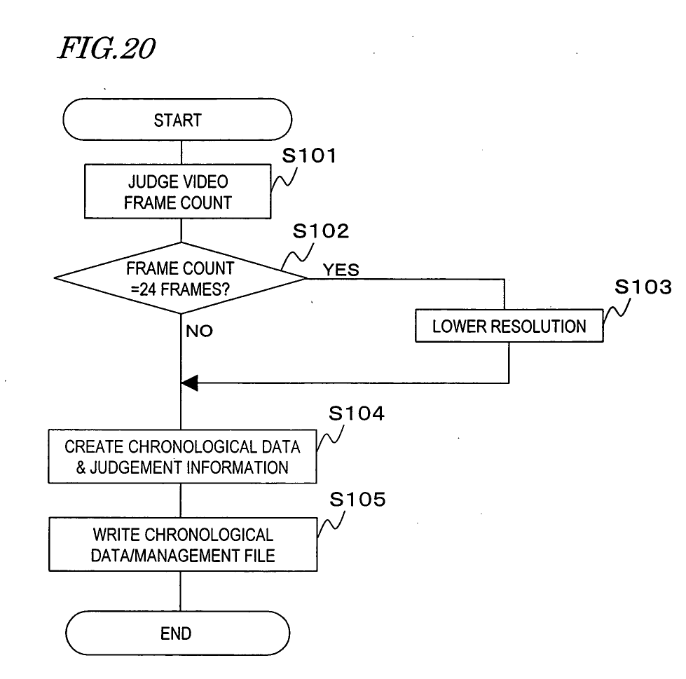

FIG. 20 shows the steps of the recording process of the video camera 3 according to the present embodiment. The processes in steps S101, S102 and S103 are the same as those in steps S011, S012 and S013 of FIG. 10.

In step S104, the moving picture stream generator 202 performs the encoding process at the selected resolution, generating chronological data (moving picture stream). Then, the management information generator 108 generates judgement information. More specifically, if the process branches from step S102, the moving picture stream generator 202 encodes the video at the resolution set by the user in advance, whereas the management information generator 108 generates judgement information (“00”) corresponding to that process. On the other hand, when the process in step S103 is performed, the moving picture stream generator 202 encodes the video at a lower resolution instructed by the resolution adjustment section 107, whereas the management information generator 108 generates judgement information (“01”) corresponding to that process. It is to be noted that when the management information generator 108 generates judgement information, the management file generator 109 generates management information such as encoding information including that judgement information.

In step S105, in response to enabling of the writing of the moving picture stream from the controller 105, the writing section 106 writes the chronological data file of the moving picture stream to the AV data area 133 of the DVD-RAM disc 131 via the pickup 130. The writing section 106 also writes the management file to the management information area 132 of the DVD-RAM disc 131.

The above process allows the video camera 3 to write the moving picture stream at a lowered video quality if the shot target is cinema movie, thus protecting the copyright of the cinema movie.

Description will be given next of the process in which the video camera 3 reads out the moving picture stream from the DVD-RAM disc 131 and plays back the video.

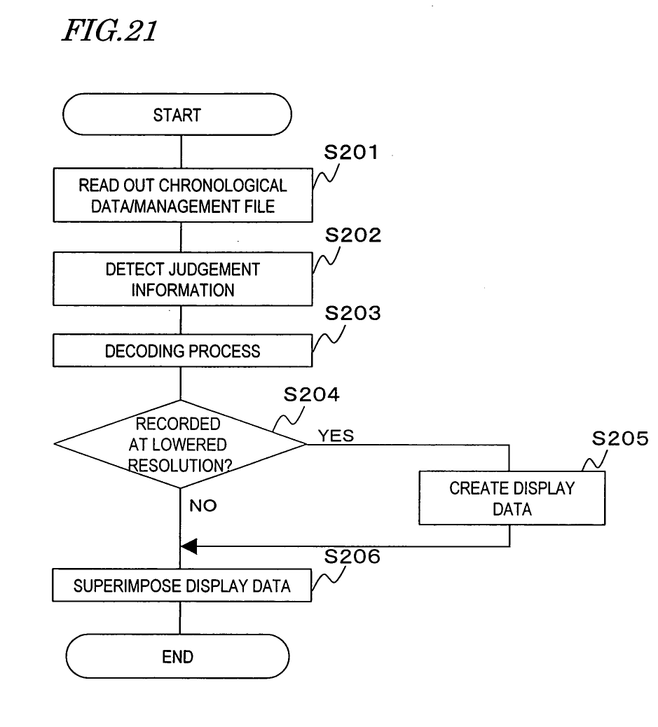

FIG. 21 shows the steps of the playback process of the video camera 3 according to the present embodiment. This process is executed as the user identifies the video to be played back and instructs the start of the playback. First, in step S201, when the playback controller 115 instructs the readout of the chronological data file of the video to be played back and the corresponding management file, the playback section 116 reads out the chronological data file and the management file from the DVD-RAM disc 131 via the pickup 130. The management information memory 120 stores the management file.

In step S202, the judgement information extraction section 121 analyzes the management file stored in the management information memory 120, extracting the judgement information.

In step S203, the moving picture stream decoder 112 decodes the moving picture stream of the moving picture file, acquiring video and audio signals. The video and audio signals are output respectively to the superimposing processor 122 and the audio signal output section 111.

In step S204, the judgement information extraction section 121 judges, based on the judgement information, whether the video was recorded at a lowered resolution at the time of the encoding. For example, when “01” is set as the judgement information, this means that the encoding was performed at a lowered resolution. In step S205, the judgement information extraction section 121 generates data showing whether the video was “recorded at a lowered resolution” (display data). Character data is, for example, used as the display data to make clear that the video has been encoded at a lowered resolution.

In step S206, the superimposing processor 122 superimposes the display data on the video signal to be played back. The video signal superimposed with the display data is output from the video signal output section 110.

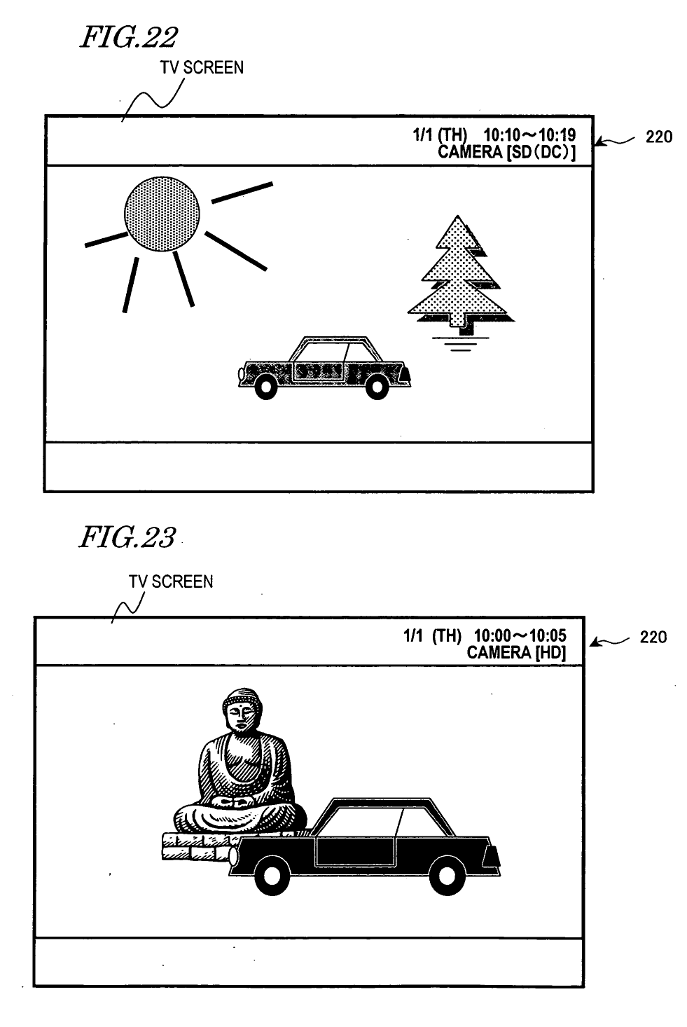

FIG. 22 shows a first example of the playback and display on the TV monitor. The superimposed display data is shown in an upper right area 220 of the screen. The display data is:
Recording date: 1/1 (Thu) 10:10 to 10:19
Video source: Camera
Recording information: SD (DC)

“Recording information” represents the resolution at the time of the recording, with “SD” indicating the standard resolution and “DC” indicating that the recording was conducted at a lowered resolution (that a down conversion was performed). In FIG. 22, the display data informs that the recording was conducted at a lowered resolution because the shot target was 24-frame-per-second video or a cinema movie.

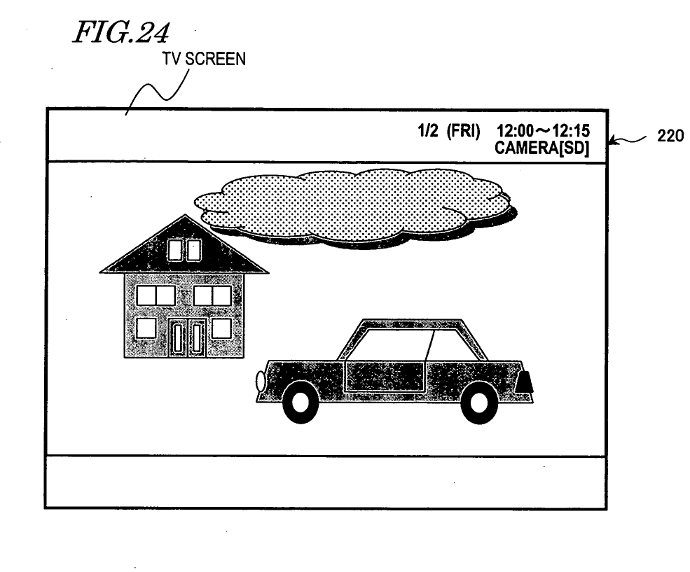

FIG. 23 shows a second example of the playback and display on the TV monitor. “HD” is shown in the upper right area 220 of the screen that indicates that the video was recorded at the high and unlowered resolution. FIG. 24 shows a third example of the playback and display on the TV monitor. “SD” is shown in the upper right area 220 of the screen that indicates that the video was recorded at the standard resolution. FIG. 24 is an example of the recording of the video at the “standard resolution” from the beginning. Therefore, since the shot target is not 24 pictures per second and the video camera 3 did not encode the video at a lowered video quality, “DC” is not shown.

As described above, in the present embodiment, the video camera 3 detects whether a work such as a cinema movie was shot and records the video at a lowered resolution if the video camera 3 judges that the video is a copyrighted cinema movie or work. The video camera 3 retains, as the management information, the judgement information indicating whether the video was encoded at a lowered resolution and displays the video based on the judgement information at the time of the playback. The video camera 3 can notify the user that the recording was conducted at the “standard resolution”, irrespective of whether the encoding at the “high resolution” was initially set at the time of the recording. Therefore, based on the notification, the user can recognize inadvertent recording of a copyrighted work such as a cinema movie, thus preventing the user from mistaking the resolution change for a camera malfunction.

It is to be noted that the judgement information has been described as being stored chunk by chunk in the sample description entry 515 described in FIG. 17. However, the judgement information may be stored in a track header atom 506 (FIG. 17). This allows showing that a portion exists in the moving picture file that was recorded at a lowered resolution. Moreover, the data field need not be defined for each chunk, thus allowing reduction in data size. Besides, the judgement information is not limited to the data structure described in FIG. 17 and others. It is to be noted that when the portion, recorded at a lowered resolution as a result of the judgement that the shot target was a work such as a cinema movie, is played back, the faithfulness to the shot target can be further lowered, for example, by showing a message superimposed on the full screen (shown at the upper right area in the description), by outputting the played-back video superimposed with special effects (mosaic, watermark) or by outputting copy protection information (e.g., Macrovision signal) superimposed on the video at the time of the playback.

On the other hand, a display/output section may be provided in the video camera 3 for showing the judgement information, instead of indicating whether or not the resolution is lowered, superimposed on the TV screen during playback of the video. The display/output section may be a vacuum fluorescent display, LED (light-emitting diode), lamp (electric bulb) or others. A drive circuit for driving these devices may be incorporated in the display/output section. Provision of the display/output section eliminates the need to use part of the video display area during the video playback, thus allowing presenting the user with necessary information while at the same time resolving the difficulty to see the played-back video. In this modification, the process of driving the display/output section is executed instead of the process of superimposing the display data in steps S205 and S206 in FIG. 21. It is to be noted that the video signal and the resolution are output in association with each other.

### Embodiment 4

The video camera according to the embodiment 3 has been described as generating judgement information for a moving picture stream and storing the judgement information in the DVD-RAM disc 131 as part of the management information.

The video camera according to the present embodiment generates judgement information for each of a plurality of the moving picture streams and stores the judgement information in the DVD-RAM disc 131 as part of each piece of the management information. Then, the video camera generates a content management file for managing the management information corresponding to each of the moving picture streams in a unified manner, storing the content management file in the DVD-RAM disc 131. It is to be noted that in the present embodiment, information equivalent to “judgement information” in the embodiment 3 is referred to as “content judgement information.”

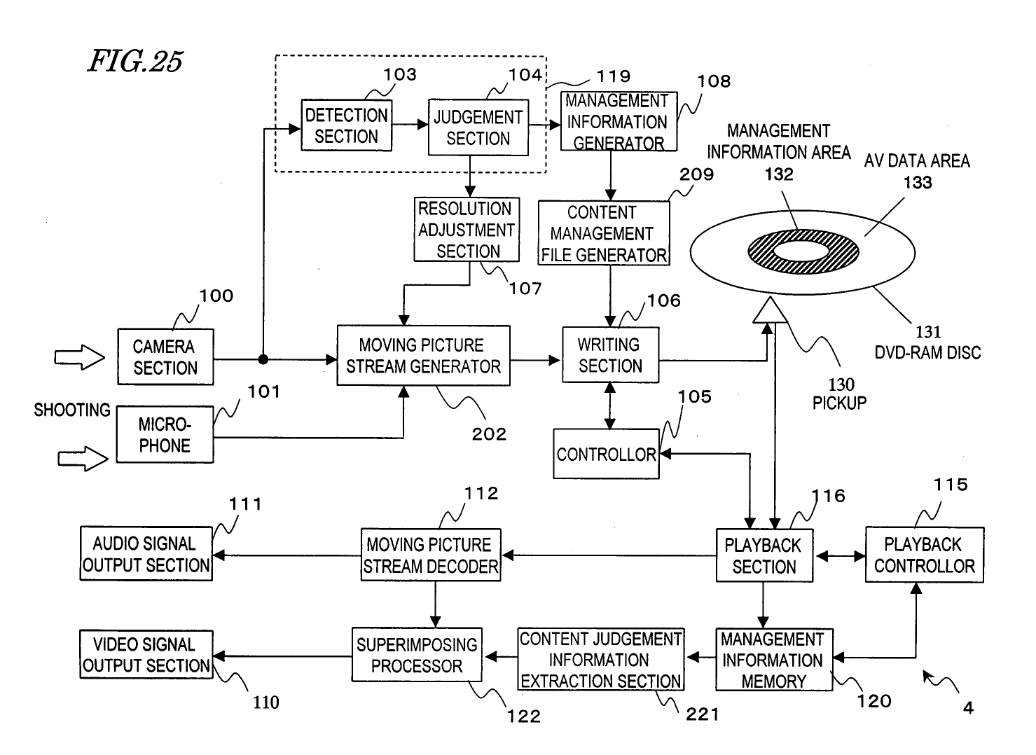

FIG. 25 shows a configuration of the functional block of a video camera 4 according to the present embodiment. The video camera 4 according to the present embodiment differs from the video camera 3 according to the embodiment 3 in that a content management file generator 209 and a content judgement information extraction section 221 are provided in place of the management file generator 109 and the judgement information extraction section 121 of the video camera 3.

It is to be noted, however, that the content management file generator 209 has the capabilities of the management file generator 109 and further has the capability of generating a content management file. On the other hand, the content judgement information extraction section 221 has the capabilities equivalent to those of the judgement information extraction section 121 and performs the equivalent processes. Therefore, the video camera 4 has the capabilities to generate information for judging whether the encoding was performed at a lowered resolution and to notify that information to the user.

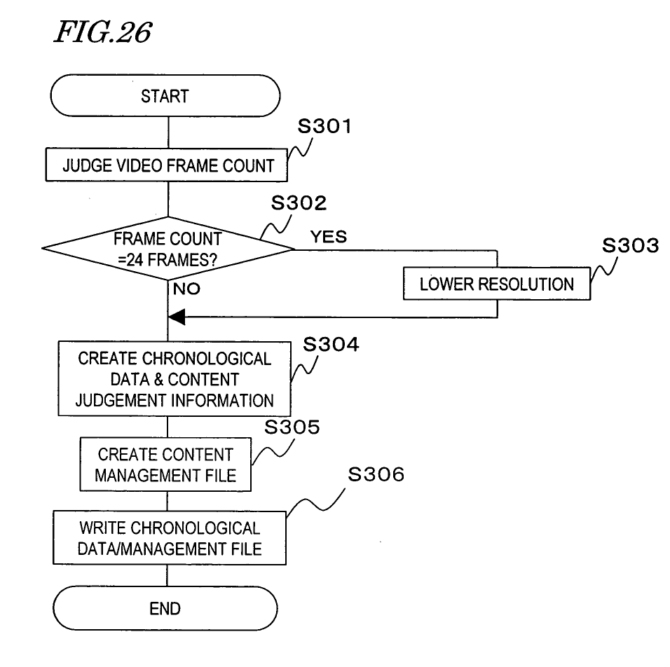

FIG. 26 shows the steps of the recording process of the video camera 4 according to the present embodiment. The recording process performed in the video camera 4 is substantially the same as the recording process of the video camera 3 according to the embodiment 3 (FIG. 20) with the exception of the creation or updating of the content management file. More specifically, the processes from steps S301 to S306 are the same as those in FIG. 20 except for step S305. For this reason, description of the processes will be omitted. “judgement information” need only be replaced with “Content judgement information.”

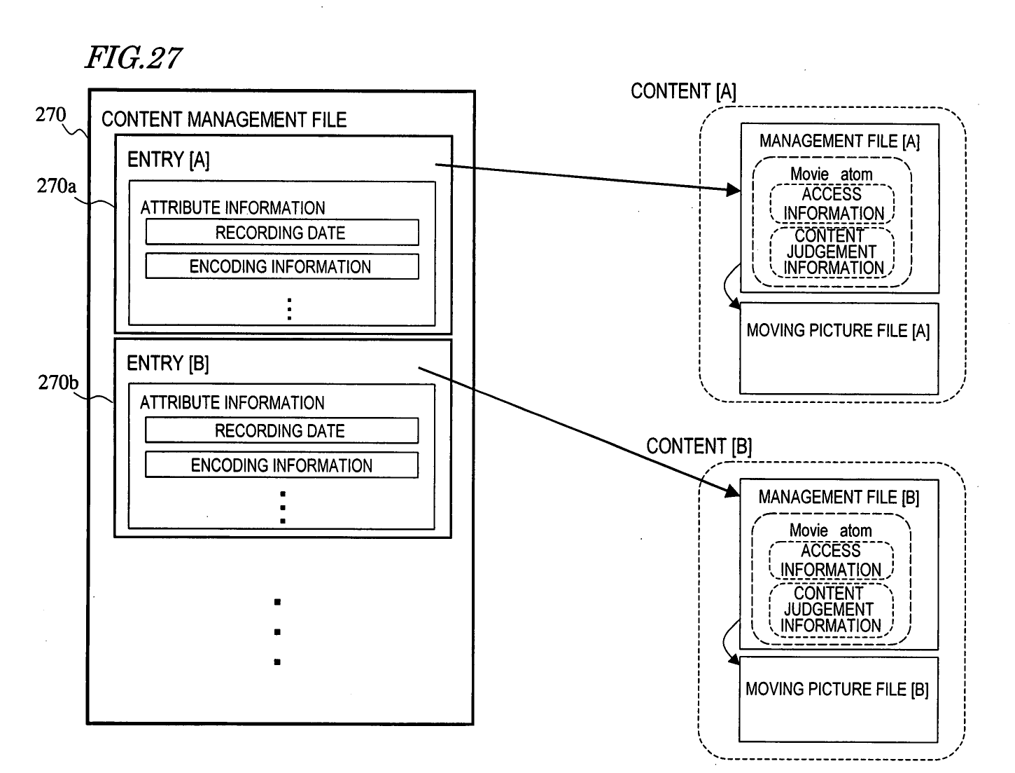

Description will be given below of the data structure of the content management file with reference to FIG. 27. It is to be noted that in the present embodiment, a pair of a corresponding management file and chronological data file (moving picture file) is referred to as “content.”

FIG. 27 shows the data structure of a content management file 270. The content management file 270 has an entry for each piece of content (moving picture file, still image file) and manages the moving picture files and the management files of the moving picture files written on the DVD-RAM disc 131 in a unified manner. For example, an entry [A] 270a is assigned to a moving picture file [A] and a management file [A] that will together be content [A]. An entry [B] is similarly assigned to content [B].

In each of the entries, attribute information related to the corresponding content is defined. The attribute information includes a recording date, shooting source, file size, link information and encoding-process-related information (encoding information). The recording date is the date and start/end times of the shooting. As for the shooting source, “Camera” is written to indicate that the shooting was conducted by the video camera 4, whereas if a TV broadcast program is recorded, for example, with a DVD recorder, the channel number is written. The encoding information, the same as that described in the embodiment 1, includes “content judgement information” corresponding to the judgement information. Further, the encoding information may include information related to “recording mode”, “encoding rate”, “resolution” and so on.

As with the judgement information in the embodiment 3, the encoding process is performed at the resolution set at the time of the shooting when the content judgement information is “00” and at a lowered resolution if the content judgement information is “01.” On the other hand, the encoding process is performed at an increased resolution when the content judgement information is “10,” It is to be noted that the meaning of “11” is undefined.

The content management file generator 209 generates the content management file shown in FIG. 27. For example, the content management file generator 209 can copy the content judgement information—information stored in the encoding information 518 of the management information 13 (FIG. 17) described in the embodiment 3—and store the information in the content management file. This offers the advantage to share common information in the management files and data.

The details of the playback process of the video camera 4 for playing back the video from the DVD-RAM disc 131 after writing various files to the DVD-RAM disc 131 are the same as those of the playback process of the video camera 3 according to the embodiment 3 (FIG. 21), and the description of the playback process of the video camera 3 also applies to the present embodiment.

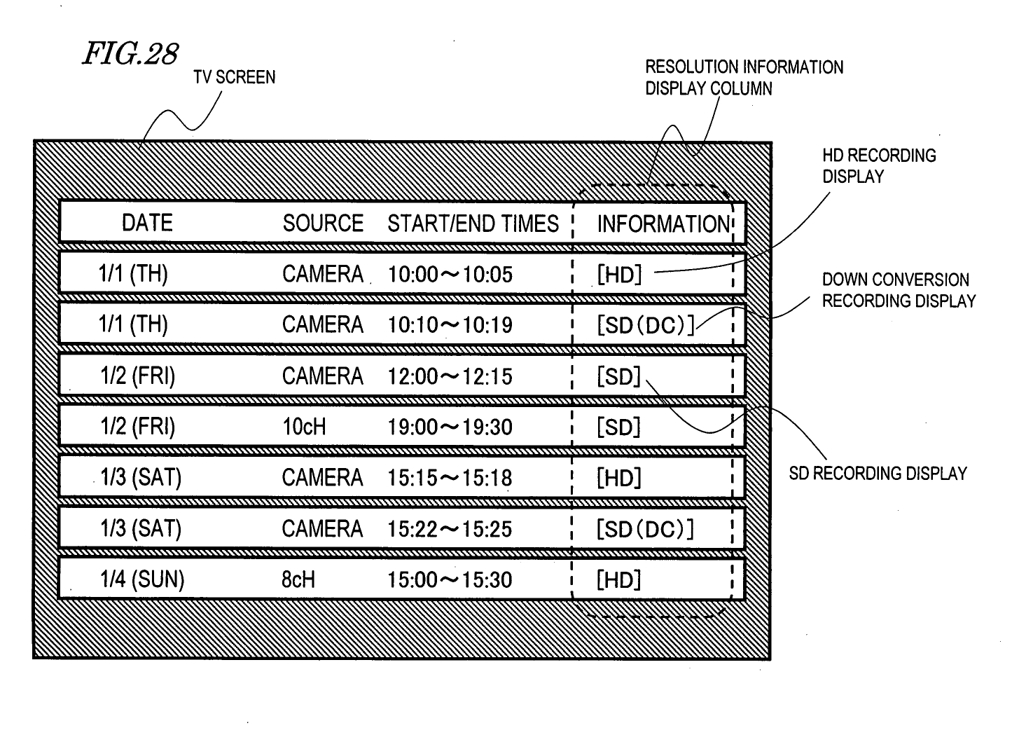

Further in the present embodiment, a list of content can be shown using the content management file to confirm the details of the content written on the DVD-RAM disc 131. FIG. 28 shows an example of a content list display screen displayed based on the content management file.

As described above, the recording dates, shooting sources, encoding information and others are stored in the content management file. The content judgement information extraction section 221 extracts, for example, the encoding information from among these pieces of information, thus generating list data to show each piece of content in correspondence with the resolution of that piece of content. The list data is intended to show the correspondence in table form shown in FIG. 28.

Here, the “Information” item in FIG. 28 is a resolution information display column showing the resolution at the time of the recording. A symbol is written in this column, including “HD” indicating the high resolution recording, “SD” indicating the standard resolution recording and “SD (DC)” indicating that the recording was conducted at a lowered standard resolution. For example, the content judgement information extraction section 221 identifies the resolution as “HD” or “SD” from the fact that the content judgement information value is “00” and from the encoding rate. On the other hand, if the content judgement information value is “01”, the content judgement information extraction section 221 identifies the resolution as “SD (DC).”

In the present embodiment, the video camera 4 not only offers the same effect as with the video camera 3 according to the embodiment 3 but also stores, in the content management file, the judgement information such as that indicating whether the recording was performed at a lowered resolution and displays the information as necessary. In the presence of only content-by-content management files, showing a list takes time as this requires access to and analysis of each of the management files. However, storing the judgement information in the content management file contributes to faster display of the list.

It is to be noted that the individual entries of the content management file may further store the following information. Included among the information are that indicating that the content is a recording of the shot target that changes at the rate of 24 pictures per second, that indicating the video change cycle of the shot target (also called “frame rate”) and that indicating the presence/absence of overlapping fields/frames resulting from recording with 30 pictures in the stream instead of 24 pictures. Further storing these pieces of information allows making more information about the shot target known to the user.

In the above-described embodiments, the configurations and processes for image shooting with the video camera have been described. However, the present invention is applicable to a streaming and other video signals that are transferred through an electric communication circuit or a wireless circuit. In this case, the Ethernet terminal of the data processing device, for example, takes the place of the camera section 100 of the video camera in obtaining the video signal. On the other hand, the data structures described in the embodiments 3 and 4 are examples, and the data structure is not limited thereto. While in the embodiments according to the present invention, the detection of the video picture count has been explained using the field memories 1031 and 1032 as an example, frame memories or other devices may also be used.

Further, while in the embodiments according to the present invention, description has been given assuming that the type of the video to judge is a cinema movie with 24 pictures per second, this is an example, and numbers of the picture count value in accordance with the type of the video for detection can be arbitrarily set. On the other hand, a judgement to determine numbers of the picture count value may be made, by setting a given threshold time at the time of the detection, when one or more specified patterns are continuously detected for the duration of the threshold time or more. This ensures improved reliability.

Further, the present invention allows judging whether the shot video is a cinema movie or similar video by analyzing the details of the shot video.

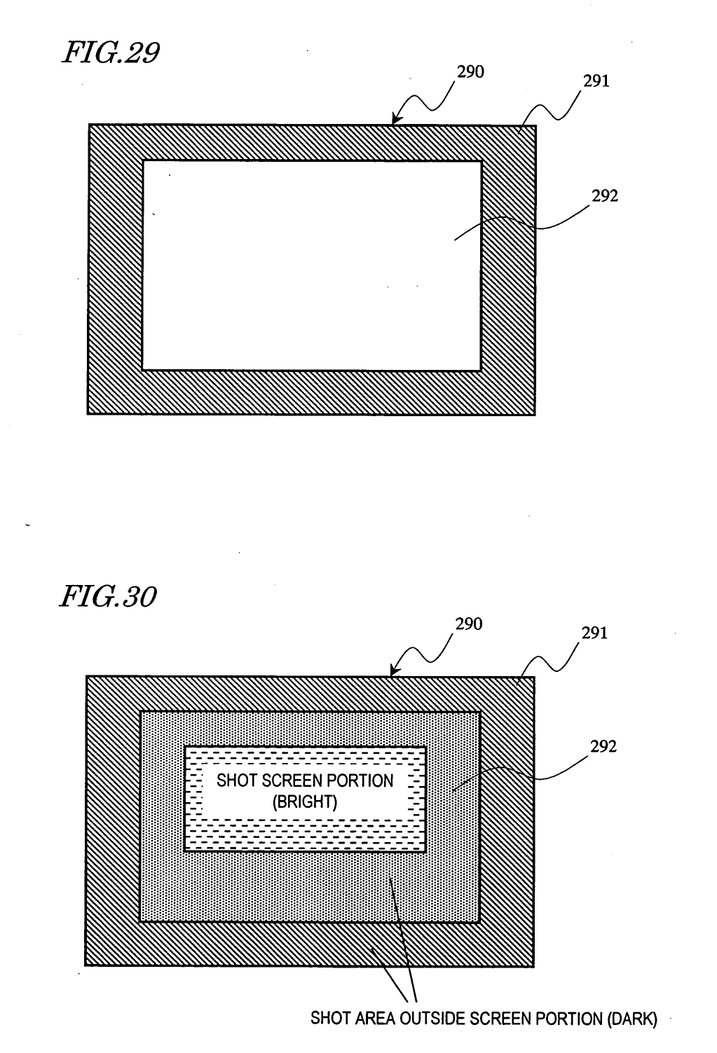

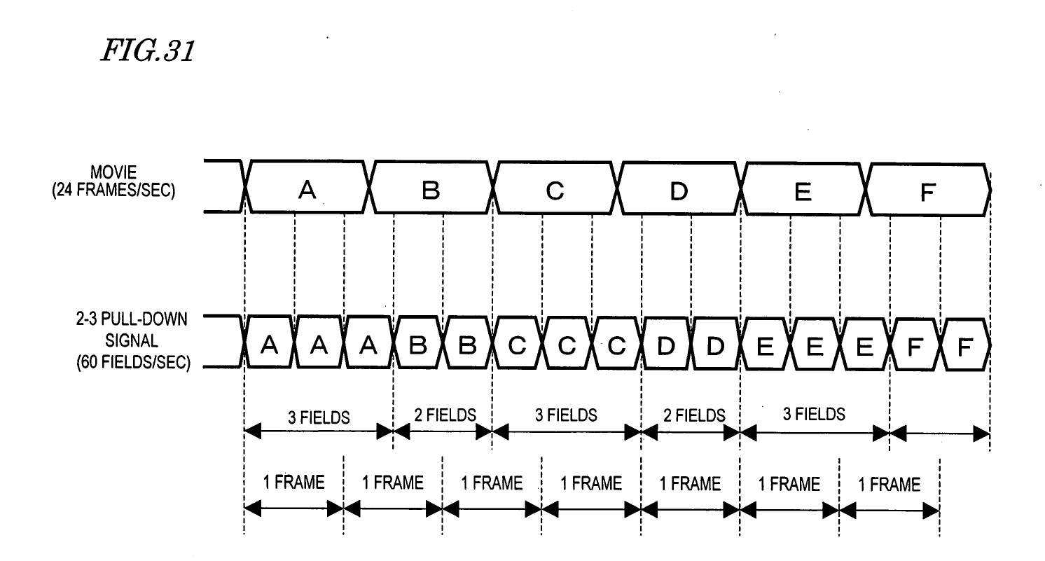

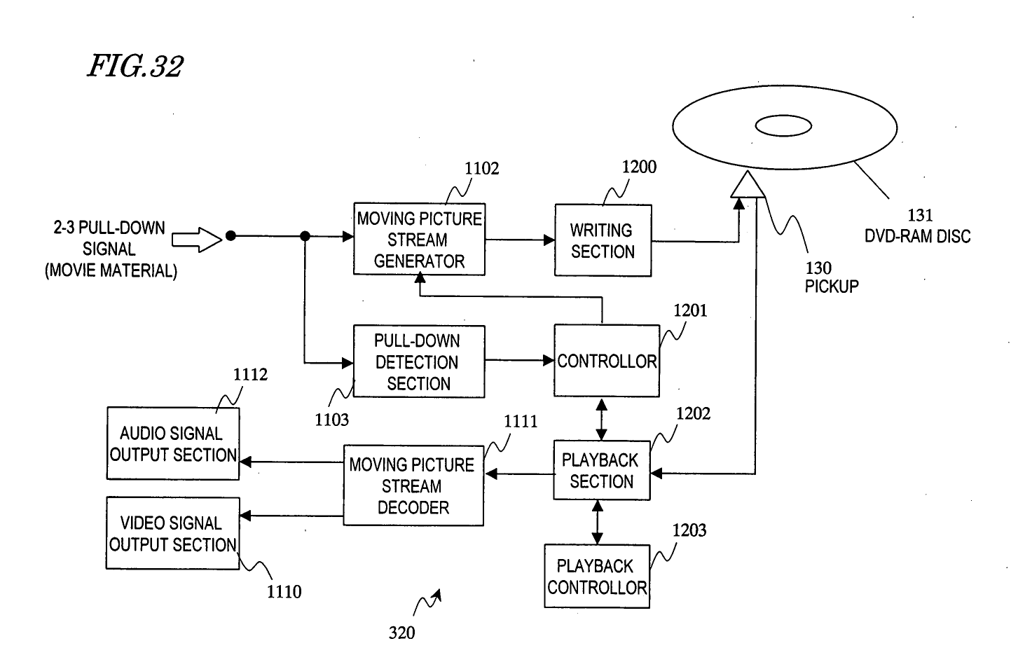

When a photo-receiving device such as CCD (Charge Coupled Device) or CMOS (Complementary Metal Oxide Semiconductor) is employed as the imaging device of the camera section, the effective pixel count (number of imaging elements in the imaging device actually used for image shooting) is smaller than the total pixel count (total number of imaging elements). FIG. 29 shows the relationship between a total pixel area 291 and an effective pixel area 292 in relation to an imaging device 290. In FIG. 29, the area corresponding to the total pixel count is shaded, whereas the area corresponding to the effective pixel count is blank.

FIG. 30 is a schematic diagram of the shooting of a cinema movie projected onto the screen using the imaging device 290. When a cinema movie being shown is shot, the shooting is presumably conducted such that the screen portion fits into the effective pixel area 292. The area outside the effective pixel area 292 will shoot the periphery of the screen. The screen portion is relatively bright because of reflection of the projected light (cinema movie) from the projector, whereas the area outside the screen portion is generally extremely dark as compared with the screen portion so that the screen stands out. This results in a large difference in brightness being detected by the imaging device between inside and outside the effective pixel area. This difference can be used to detect whether the shot target is the screen.

Further, by considering the imaging device's horizontal-to-vertical ratio (aspect ratio; e.g., 4:3), the aspect ratio of the effective pixel area during the shooting (4:3 or 16:9 horizontal-to-vertical) and further the following movie aspect ratios, judgement can be made between bright and dark light entering the imaging device, thus ensuring further accurate detection. That is, the standard size is 1.33:1, the vista size in the European standard is 1.66:1, the vista size in the US standard is 1.85:1, and the Cinemascope size is 1.85:1.

Analyzing the details of the shot video using these techniques allows judging whether the shot video is a cinema movie or similar video. Making judgement using the above analyses together with the detection as to whether the picture count per second is 24 pictures allows determining the shot object type with higher accuracy.

While in the embodiments according to the present invention, description has been given assuming that the recording is made on the optical disc such as a DVD-RAM, the recording may be made on a non-volatile memory device such as a semiconductor memory or a magnetic recording medium such as a harddisk. On the other hand, while description has been given taking the MPEG2 video stream as an example of the data stream to be written, other video streams including the MPEG4 video stream may be applied.

The recording and playback capabilities of the data processing device typified by a video camera function based on a computer program implementing such capabilities. The computer program can, for example, cause a computer system to function as a recording device and/or playback device if recorded on a recording medium such as a CD-ROM and circulated in the market or if transferred through an electric communication circuit such as the Internet.

According to various preferred embodiments of the present invention described above, a type of the video is identified based on the video signal, which is determined in accordance with picture counts of the video displayed per unit time. If the target shot by the camera is film video such as a cinema movie, the recording of the video is halted, or the recording the video with a sufficiently lowered resolution is performed. This prevents the copyright infringement of the content copyright owner, thus protecting the content.

This application is based on Japanese Patent Applications No. 2003-349248 filed on Oct. 8, 2003, No. 2004-072552 filed on Mar. 15, 2004 and No. 2004-291362 filed on Oct. 4, 2004, the entire contents of which are hereby incorporated by reference.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

1. A data processing apparatus for writing a video stream related to video on a recording medium, comprising:
a signal acquisition section for acquiring a video signal related to the video;
a type identification section for identifying a type of the video based on the video signal, the type of the video being determined in accordance with picture counts of the video displayed per unit time;
a stream generator for generating a video stream based on the video signal;
a controller for determining, based on the type of the video, whether to disable the writing of the video stream or to enable the writing of the video stream with lowered video quality; and
a writing section for controlling, based on the decision of the controller, the writing of the video stream to the recording medium.

2. The data processing apparatus of claim 1, wherein the controller disables the writing of the video stream in the case where the type of the video is a movie.

3. The data processing apparatus of claim 1, further comprising an adjustment section for selecting a video quality based on the type of the video, wherein the stream generator generates the video stream with selected video quality.

4. The data processing apparatus of claim 3, wherein in the case where the type of the video matches a predetermined type, the controller determines to enable the writing of the video stream with lowered video quality, and wherein the adjustment section selects video quality lower than that set in advance.

5. The data processing apparatus of claim 3, wherein in the case where the type of the video does not match a predetermined type, the controller determines to enable the writing of the video stream with the video quality preserved, and the adjustment section selects the same video quality as set in advance.

6. The data processing apparatus of claim 3, wherein the adjustment section selects the video quality in relation to a resolution.

7. The data processing apparatus of claim 1, wherein the type identification section includes:
a detection section for continuously receiving the video signal and for detecting whether first and second images consisting of each picture of the video, match or mismatch; and
a judgement section for judging the type of the video based on the detection result.

8. The data processing apparatus of claim 7, wherein the detection section includes:
a first memory for storing data of the first image;
a second memory for storing data of the second image; and
a comparator for comparing the data in the first memory with that in the second memory, the comparator detecting whether the first and second images match each other.

9. The data processing apparatus of claim 7, wherein the judgement section continuously receives each detection result and specifies the type of the video based on a pattern of match and mismatch appeared in the each detection result.

10. The data processing apparatus of claim 6, further comprising a management information generator for generating judgement information indicating at which of a first resolution and a second resolution lower than the first resolution the video was encoded, the management information generator managing the judgement information in association with the video stream, wherein the writing section further writes the judgement information to the recording medium.

11. The data processing apparatus of claim 10,
wherein the management information generator manages a plurality of contents, each of which including a pair of the judgement information and the video stream associated with each other,
the data processing apparatus further comprising a management file generator for extracting the judgement information from each content and generating a content management file having entries for each content.

12. A data processing apparatus for reading out a video stream related to video from a recording medium to output a video signal,
wherein the video stream and management information are written on the recording medium, and
wherein the management information contains judgement information indicating the video being encoded in first video quality and second video quality lower than the first video quality,
the data processing apparatus comprising:
a readout section for reading out the video stream and the management information from the recording medium;
an extraction section for extracting the judgement information from the management information and for generating, based on the judgement information, quality display data indicating at which of the first video quality and the second video quality the video was encoded;
a decoder for decoding the video stream to generate a video signal; and
an output section for outputting the quality display data and the video signal in correspondence with each other.

13. The data processing apparatus of claim 12,
wherein in the case where the type of the video matches a predetermined type, the judgement information indicates that the video was encoded at the second video quality, and
wherein in the case where the type of the video does not match a predetermined type, the judgement information indicates that the video was encoded at the first video quality.

14. The data processing apparatus of claim 13, further comprising a superimposing processor for superimposing the quality display data on the video signal, wherein the output section outputs the video signal superimposed with the quality display data.

15. The data processing apparatus of claim 13, wherein the output section includes a video signal output section for outputting the video signal and a display output section for displaying the quality display data.

16. The data processing apparatus of claim 12,
wherein a plurality of contents are stored on the recording medium, each of which including a pair of the judgement information and the video stream associated with each other,
wherein each piece of the judgement information is stored in a content management file having an entry for each piece of the content, and wherein the extraction section extracts the judgement information from the content management file to generate list data for displaying content corresponding to each entry and the quality display data in correspondence with each other.

17. A data processing method for writing a video stream related to video on a recording medium, comprising steps of:
acquiring a video signal related to the video;
identifying a type of the video based on the video signal, the type of the video being determined in accordance with picture counts of the video displayed per unit time;
generating a video stream based on the video signal;
determining, based on the type of the video, whether to disable the writing of the video stream or to enable the writing of the video stream with lowered video quality; and
controlling, based on the determination, the writing of the video stream to the recording medium.

18. The data processing method of claim 17, wherein the step of determining determines to disable the writing of the video stream in the case where the type of the video is a movie.

19. The data processing method of claim 17, further comprising a step of selecting a video quality based on the type of the video, wherein the steps of generating generates the video stream with selected video quality.

20. The data processing method of claim 19, wherein in the case where the type of the video matches a predetermined type, the step of determining determines to enable the writing of the video stream with lowered video quality, and wherein the step of selecting selects video quality lower than that set in advance.
